(19) United States
(12) Patent Application Publication
(10) Pub. No.: US 2012/0271715 A1
(43) Pub. Date: Oct. 25, 2012

(54) SYSTEM AND METHOD FOR THE AUTOMATIC DELIVERY OF ADVERTISING CONTENT TO A CONSUMER BASED ON THE CONSUMER'S INDICATION OF INTEREST IN AN ITEM OR SERVICE AVAILABLE IN A RETAIL ENVIRONMENT

(76) Inventors: Timothy B. Morton, Kirkland, WA (US); Timothy Belvin, Woodinville, WA (US)

(21) Appl. No.: 13/430,621

(22) Filed: Mar. 26, 2012

Related U.S. Application Data
(60) Provisional application No. 61/467,953, filed on Mar. 25, 2011.

(51) Int. Cl. G06Q 30/02

(52) U.S. Cl. 705/14.53

(57) ABSTRACT

A system and method provides targeted advertising content to a consumer based on implicit or explicit indications of interest by the consumer regarding products or services available in a retail environment. The retail environment is divided into a number of detection regions, with each detection region containing one or more display devices. The system can detect the location of a marker associated with a customer within the detection region. The system uses location information, as well as other customer information, to estimate a customer's goals for a particular shopping trip. The estimate may be determined based on the customer's time spent at a particular location, speed, basket size, etc. The system then presents advertisements to the customer based on the estimated goals.

### CROSS-REFERENCE TO RELATED APPLICATION

This application claims priority to and the benefit of U.S. Provisional Patent Application No. 61/467,953, entitled “SYSTEM AND METHOD FOR THE AUTOMATIC DELIVERY OF ADVERTISING CONTENT TO A CONSUMER BASED ON THE CONSUMER'S INDICATION OF INTEREST IN AN ITEM OR SERVICE AVAILABLE IN A RETAIL ENVIRONMENT”, filed Mar. 25, 2011, which is incorporated herein by reference in its entirety.

### BACKGROUND

The vast majority of advertising content is delivered to consumers at a time when consumers are not actively making a purchasing decision. For example, advertising content in the form of consumer promotions, such as coupons, are delivered in physical form via mail or in Free Standing Inserts (FSIs) in newspapers or other forms of published media. To be effective, these consumer promotions must not only be viewed by consumers—a daunting problem, given the size of newspapers, magazines and other print media—but must also generate a sufficient impression on consumers to cause consumers to change their purchasing behavior when later shopping at a retail store. Given the hurdles for consumer promotions to be successful, it is therefore not surprising that the vast majority of coupons are never actually redeemed and that return on advertising dollar spent can be quite small. As another example, the presentation of advertising on television has long been one of the most important channels for advertisers to reach consumers with advertising content. While advertisers may be more confident that consumers are actually being exposed to advertising content that is presented on television, consumers receive the content at a time when they are engaged in the passive activity of watching television programming. As with print ads, the advertiser must therefore count on the advertising content making a sufficiently large enough impression on consumers to cause consumers to later change their purchasing behavior at a point of purchase.

With the creation of the World Wide Web and the launch of commercial websites through which products and services could be purchased, some of the challenges of reaching consumers at a time when consumers are making a purchase decision changed. By advertising on websites, advertisers were suddenly able to target consumers based on the website that they are visiting, the products or services that they are looking at and considering purchasing, and other characteristics of the consumer, such as past purchases or express indications of preference. By moving advertising online and closer to a consumer's point of purchase, advertisers are able to have a greater impact on the purchasing behavior of consumers. A shortcoming of advertising on websites, however, is that only a small fraction of total purchase transactions are performed on the web. Most purchases are still completed in brick-and-mortar stores.

In sum, although websites have allowed advertisers to move closer to the point of purchase, the vast majority of advertising is still being delivered to consumers via print or television media at a time and location distant from the point of purchase. To date, no solution has been able to marry the effectiveness of online advertising to the inherent volume advantage provided by traditional brick-and-mortar retailers.

### BRIEF DESCRIPTION OF THE DRAWINGS

FIG. 1A is a perspective view of a retail environment containing display devices that display advertising content to consumers that are present in the retail environment.

FIG. 1B is an overhead view of a retail environment depicting detection regions and display zones that are mapped within the environment.

FIG. 1C is a front view of a representative display device that displays advertising content to a consumer.

FIG. 2 is block diagram of a system that detects indications of region and zone events associated with a consumer in a retail establishment and identifies relevant advertising content for presentation to the consumer on a display device.

FIG. 3 is a flow diagram of a process implemented by a region manager to detect a region or zone event associated with a consumer and generate various HTTP requests to a session manager, such as a request for the delivery of relevant advertising content to a display device in response to a zone event.

FIGS. 4A-4C are flow diagrams of processes implemented by the session manager to receive and process region or zone events that are sent by the region manager.

FIG. 5 is a flow diagram of a process implemented by the session manager to select relevant advertising content for presentation to a consumer based on a received HTTP request.

FIG. 6 is a flow diagram of a process that is executed by the display device to receive an HTTP response from the session manager and present the selected advertising content on the display device to a consumer.

FIG. 7 is a representative session log for storing session data associated with the region and zone events of a consumer.

FIG. 8 is a graph of a model of the approximate effectiveness of advertisements with respect to time presented to a consumer prior to purchase.

FIG. 9 is a graph representing the display of multiple pieces of advertising content by the disclosed system to consumers under various scenarios prior to purchase.

FIG. 10 is a flow diagram of a representative process implemented by the disclosed system to determine advertising content to display to a consumer while inside of a retail environment.

FIG. 11A-11G is a mind map of various factors that may be taken into account when selecting targeted advertising content to deliver to a consumer.

### DETAILED DESCRIPTION

A system and method for the automatic delivery of targeted advertising content to a consumer based on the consumer's indication of interest in an item or service available in a retail environment. The retail environment may be divided into a number of detection regions, with each detection region monitored by a region manager and optionally containing one or more display devices. The one or more display devices may comprise a unit that resides at a fixed location within the display zone, such as on a shelf alongside retail items. The one or more display devices also may comprise a unit that is affixed to a shopping basket or cart, or a portable unit having a display screen, such as a cellular telephone that travels with the consumer. Each display device may have an associated display zone in which a consumer is likely to be exposed to advertising content that is being presented on the display device. Alternatively, each display device may be associated with the zone in which it is located, an adjacent zone, or any other zone within the retail environment. Each display zone is associated with one or more products or categories of products. Markers, such as a radio frequency identification (RFID) tag, RuBee tag, or other tag, are associated with consumers that are visiting the retail environment. The association of a marker with a consumer that is visiting the retail environment is more fully described in U.S. patent application Ser. No. 12/621,414, filed Nov. 18, 2009, entitled “System and Method for the Correlation of Mobile Devices with Markers Used By a Content Delivery System in a Retail Environment,” and U.S. patent application Ser. No. 12/835,604, filed Jul. 13, 2010, entitled “System and Method for Correlating Electronic Advertisements Presented to Consumers on Computing Devices with Consumer Visits to Retail Environments,” which are both assigned to the same assignee as the present invention and are both incorporated herein by reference in their entirety. Each region manager can detect when a marker enters a detection region and when a marker leaves a detection region. Moreover, the region manager can detect the location of the marker within the detection region. When the detected location of the marker indicates that the marker has entered a display zone, the region manager makes a request to a session manager to deliver relevant advertisements for presentation to the consumer. The session manager responds with a response that delivers advertising content to the display device. The delivered advertising content is targeted to the consumer based on several factors, including a previous implicit or explicit indication of interest in a product by the consumer, the particular products or categories of products contained in the zone, the amount of time the consumer has spent in the current zone or in a different zone in the retail environment (i.e., the consumer's dwell time), past purchases, or other shopping behavior observed during present or prior shopping sessions. The delivered advertising content may also be targeted to the consumer based on real-time preferences of the retailer, such as product expiration dates, inventory levels, profit margins, or the need to clear older merchandise in order to create capacity for newer models or improved versions of the merchandise. The consumer is thereby presented with a very timely and targeted advertising message at the exact time when the consumer is making a purchase decision at the retail establishment.

In some embodiments, the request made by the region manager is a Hypertext Transfer Protocol (HTTP) request, and the response delivered by the session manager is an HTTP response. By using requests and responses formatted in accordance with the HTTP protocol, the disclosed system may easily integrate with existing advertising services or content that is available via the Internet or other networks. In some embodiments, rather than transmit an HTTP request, the region manager transmits a short message service (SMS) request or an ICQ request and receives responses from the session manager via a corresponding messaging protocol. By using requests and responses formatted in accordance with common messaging protocols, the disclosed system may easily integrate with existing advertising services or content that are available via mobile messaging platforms.

In some embodiments, the session manager maintains a session log that stores all region and zone events associated with a consumer's visit to a retail establishment, as well as implicit and explicit indications of interest from the consumer both before and after entering the retail establishment. The session log contains a record of all implicit and explicit indications of interest from the consumer, regions and zones that the consumer visited, certain actions the consumer performed in each zone, and subsequent purchases that the consumer made as part of a check out process. The session log may be used by the session manager to better target advertisements that are delivered to the consumer during the visit. Moreover, for those consumers that are capable of being tracked across visits (e.g., when a marker is semi-permanently associated with a consumer, such as when the marker is embedded in a store loyalty card), the session log may be stored by the session manager and a profile of the consumer's preferences constructed over time.

In some embodiments, if the marker is associated with a mobile device, the session manager may initiate a request for information from the mobile device. The request for information causes the mobile device to provide information associated with the consumer that might be used in conjunction with additional information to tailor advertisements for the consumer. Information associated with the consumer may include, but is not limited to, the consumer's product or brand preferences, coupons on the mobile device associated with products of interest to the consumer, past purchases made by the consumer, past online behavior of the consumer (e.g., a record of sites that were previously accessed, content viewed, etc.), a record of the consumer's interests, an identification of one or more loyalty programs in which the consumer participates, a record of accumulated points in the one or more loyalty programs, a record of items in which the consumer has implicitly or explicitly indicated an interest, or any other information that characterizes the consumer. Information received from the mobile device may be used by the session manager to select and deliver more relevant advertising content to the consumer.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

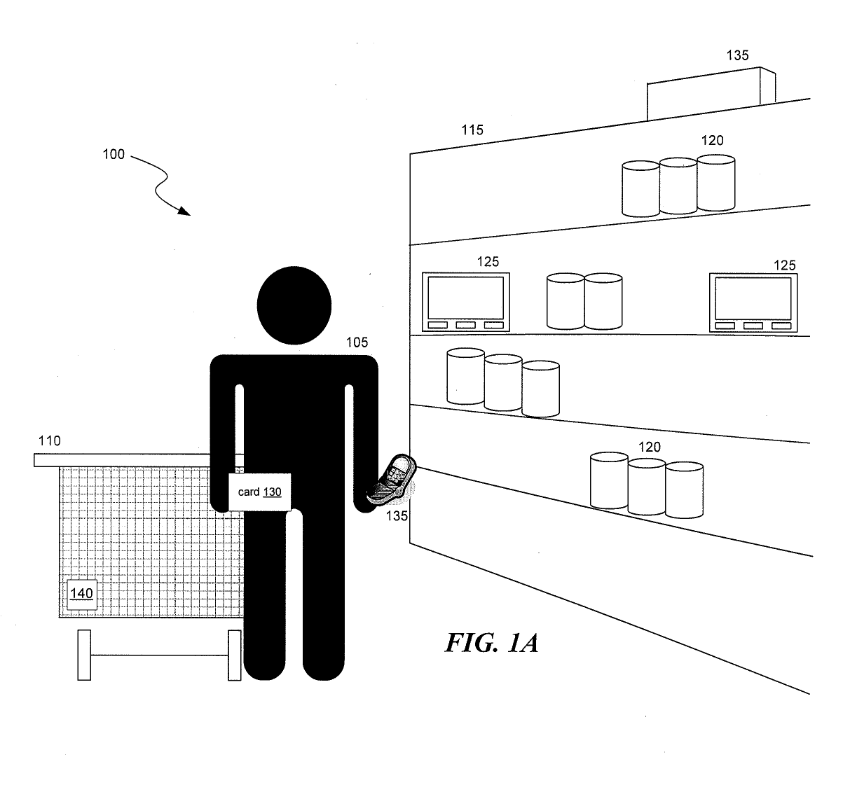

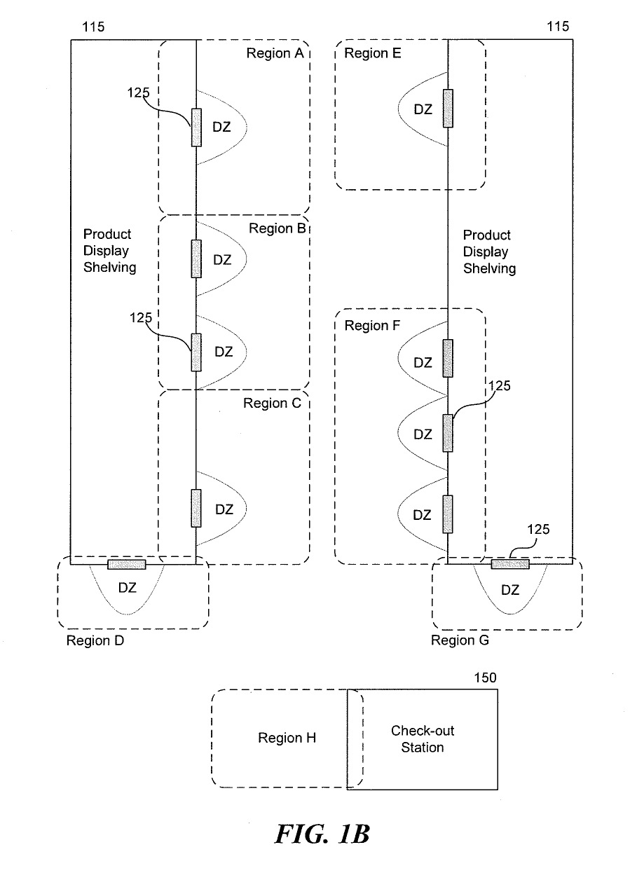

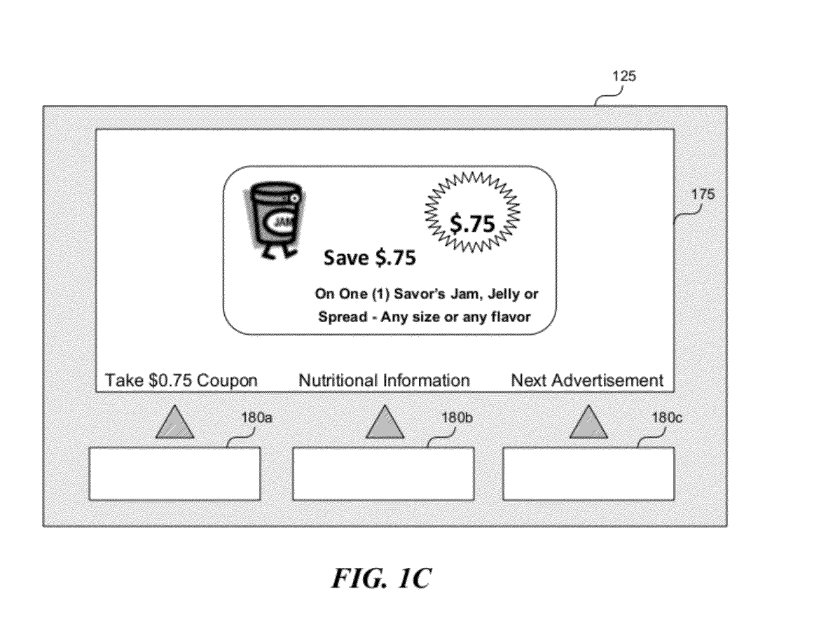

FIG. 1A is a perspective view of a retail environment 100 containing display devices 125 that present advertising content to consumers 105 that are visiting the retail environment. The retail environment may be any environment in which consumers purchase products, such as a grocery store, a drug store, an office supply store, a hardware store, an auto parts store, etc. Such retail environments normally have one or more rows of shelving 115 that allow the retailer to display various products 120 that are available for purchase by the consumer. To facilitate the purchase of products, the retailer may offer shopping carts 110 or other baskets or tote bags (not shown) that allow the consumer to carry those products that are intended to be purchased. When a consumer has selected all of the products that are to be purchased, the consumer typically proceeds to a check-out register, payment kiosk, or other check-out location to pay for the purchases.

Deployed within the retail environment 100 is a system that allows advertising content to be displayed to consumers in a targeted and trackable manner. The retail environment 100 is divided into a number of detection regions and display zones. As will be described in additional detail herein, a detection region is a region in which the presence of a marker associated with a consumer may be detected and the location of the marker in the detection region determined. The size of each detection region is determined by the monitor technology used to detect the presence and location of a marker. One or more display zones may lie within or adjacent to each detection region. Each display zone is a region in proximity to a display device 125 in which a consumer is likely to be exposed to advertising content that is presented on the display device. The display device may be a unit with a fixed location, such as a display unit set on a shelf, or the display device may be a portable unit, such as a personal cellular telephone with a display screen. The size of each display zone is dependant on such factors as the size and quality of the corresponding display device, the particular advertising content that is presented on the display, and the presence or absence of any obstructions around the display. Each display zone is associated with one or more products or categories of products that are available at the retail establishment. A display zone is typically associated with those products or categories of products that are located in proximity to the display device, since those are the product or categories of products that a consumer is in the process of purchasing when viewing advertisements on the display device.

FIG. 1B is an overhead view of a retail environment depicting detection regions and display zones that are mapped within the environment. Two sets of product shelving 115 or product displays are displayed, as well as a check-out station 150 that a consumer would visit to pay for any purchases. The aisle between the shelving 115 is divided into a number of detection regions of equal or different sizes. For example, in the depicted environment, the area around one set of product shelving is divided into four detection regions (Regions A-D) and the area around the other set of product shelving is divided into three detection regions (Regions E-G). While some detection regions (Regions A-C, E-F) extend into the aisle formed by the shelving, other detection regions (Regions D, G) extend beyond end-aisle displays. In addition, a Region H is defined near the check-out station 150 to detect the presence of consumers at the check-out station. Detection regions may be deployed in a contiguous fashion so that all or most of the shoppable area in the environment is covered by a region, or detection regions may be scattered throughout the environment in a non-contiguous fashion (e.g., Regions E and F are separated by a section of aisle that is not contained in any detection region). By appropriate layout of detection regions, the system is able to detect the location and path of travel of markers within the retail environment.

Each detection region contains one or more display devices 125 that display advertising content to the consumer. For example, Region A contains a single display device, Region B contains two display devices, and Region F contains three display devices. Each display device has a surrounding display zone (“DZ”) in which a consumer is likely to be exposed to advertising content that is being presented on the corresponding display device. Although all of the display zones in FIG. 1B are depicted as being of a similar size, it will be appreciated that the size of each display zone may vary depending on the size and quality of the corresponding display device 125, and the other factors previously mentioned herein.

Returning to FIG. 1A, each region is monitored by a region manager 135. As will be described in additional detail herein, the region manager 135 is able to detect when a marker associated with a consumer 105 enters the region monitored by the manager. The region manager 135 is also able to detect the location of the marker within the region. A “marker” is any technology component that allows the presence and location of the marker to be detected within a desired accuracy in the retail environment. For example, a marker may be a passive tag, such as a radio frequency identification (RFID) tag that operates in the VHF, UHF or SHF bands. As another example, the marker may be an active tag, such as certain RFID tags or RuBee (IEEE 1902.1) tags that operate in the LF band. Alternatively, the marker may incorporate components that allow the location of the marker to be detected using local wireless network signals or global positioning signals. For example, the location of the marker may be determined by triangulating from local Bluetooth, ZigBee, WiFi, WiMax, cellular or other personal, local, or wide area wireless network signals that are detected by the marker or which can detect the marker. As another example, the marker may incorporate an assisted global position system (A-GPS) receiver so that the marker can compute its location based on received A-GPS signals. On a periodic or aperiodic basis the marker or other wireless network components transmit the marker's location to a region manager.

The marker may be embedded in or attached to a card 130 (e.g., a store loyalty card, a credit card, a driver's license, etc.) that this associated with the retail environment and carried by the consumer, the marker may be embedded in an identification component 140 that is attached to the shopping cart 110, basket, or bag carried by the consumer, or the consumer may have a marker attached to or embedded in a mobile phone 135 or other portable device that is carried by the consumer (e.g., in a SIM card that is inserted into a mobile phone or other device). The marker may be permanently affixed or embedded within the card (e.g., in a store loyalty card), carrying apparatus or device, or the marker may be temporarily affixed (e.g., by the use of a sticker or other semi-permanent means to affix a marker to a credit card, driver's license, or mobile device). The marker may be permanently associated with the consumer, such as a marker on a driver's license, store loyalty card, or phone that is carried by the consumer during multiple visits. Alternatively, the marker may be temporarily associated with the consumer, such as with a shopping cart, basket, or bag that is used by the consumer only during a particular visit to the retail environment.

When the region manager 135 detects the presence of a marker in the associated detection region, a message is sent to a session manager indicating that the marker has entered the region. A further message is sent to the session manager requesting the delivery of advertising content for display to the consumer. In response to the request, the session manager selects and transmits advertising content to the associated display device 125 where it is presented to the consumer. The advertising presented to the consumer may relate to the one or more products or categories of products 120 that are contained in or associated with the corresponding display zone, an adjacent display zone, or any other display zone within the retail environment. Since the region manager requests advertising content when a marker is detected in the display zone, the advertising content may be selected so that it is targeted to the consumer. Moreover, the advertising content may also be selected so that it represents the most recent or up-to-date advertising that is available for the associated one or more products or categories of products. Also, since the advertising content is delivered to the consumer at the time that the consumer is making a purchase decision, the effectiveness of the advertising content will typically be significantly better than advertising delivered in other channels to the consumer.

FIG. 1C is a front view of a representative display device 125 that presents advertising content to a consumer. Advertising content may be text, images, or video, or any combination thereof, and may or may not include associated audio. The advertising content that is presented to consumers is anything that an advertiser feels will be beneficial to the sale of products. For example, advertising content may include a commercial for a product, nutritional information about the product, suggested recipes that incorporate the product, recommendations of other products that may be used in conjunction with the product, and coupons or rebates for the product. The display device 125 includes one or more buttons or other controls that allow the consumer to interact with information on the display device. For example, if the advertising content is a coupon that is displayed to a consumer, the consumer may select the coupon by pressing a button 180a on the display device. As another example, the consumer may be interested in seeing nutritional information about a displayed product. The consumer may therefore press a button 180b to cause nutritional information to be requested and presented on the display device. To view additional advertisements on the display device, the consumer may also select a “next advertisement” button 180c. Selecting the next advertisement button causes the display to present another advertisement to the consumer. While three buttons 180 are depicted on the display device 125, it will be appreciated that a greater or lesser number of buttons or other controls may be present on the display device. In some embodiments, the display device has a touch screen display that allows a consumer to touch regions of the display in order to select a desired option. In some embodiments, no buttons are contained on the display device and the consumer cannot interact with the display device other than by being exposed to the presented advertising.

When the region manager 135 determines that the marker has left the display zone, the region manager notifies the session manager and the presentation of the advertising on the display device is halted unless other markers remain in the display zone. When the region manager 135 detects that the marker is no longer in the associated detection region, a message is sent to the session manager indicating that the marker has left the region. As will be described in detail herein, the indications sent by the region manager 135 to the session manager that a marker has entered and left a detection region and zone enable the system to track and predict a path of the marker though the retail establishment.

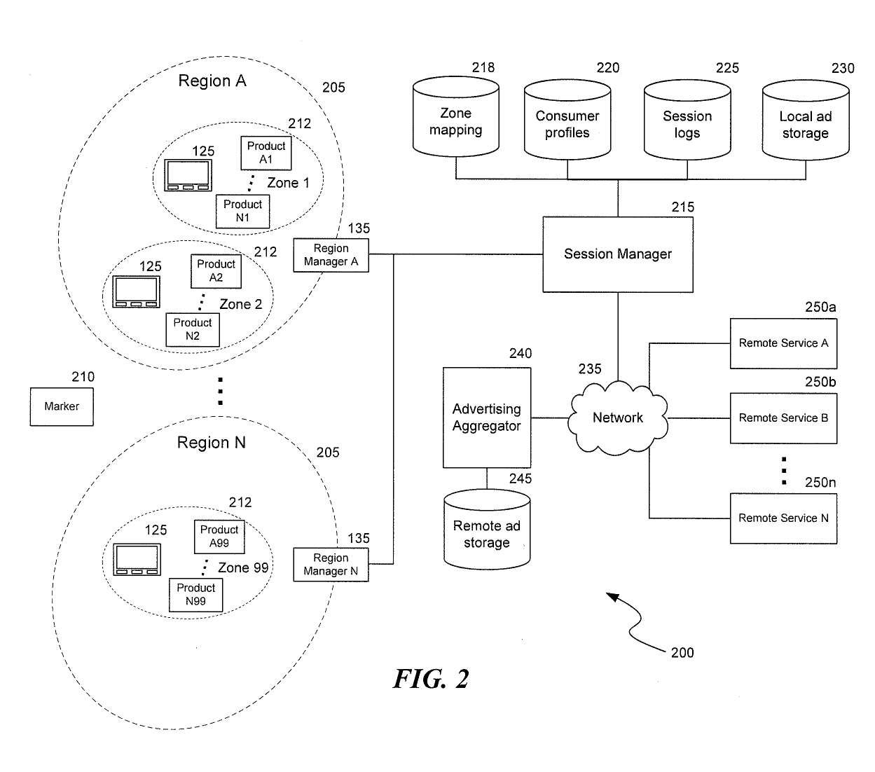

FIG. 2 is block diagram of a system 200 that detects region and zone events associated with a marker 210 in a retail establishment and identifies relevant advertising content for presentation to a consumer on one or more display devices 125. As depicted in FIG. 2, the system includes a number of region managers 135. Each region manager 135 includes a monitor that is capable of detecting markers 210 that enter into an area in proximity of the region manager. Such a detection area is referred to herein as a “detection region” 205 or simply region (e.g., Region A through Region N in FIG. 2). The monitor technology is selected such that the defined region 205 is of a generally-known size and limited range, allowing multiple regions to be deployed adjacent to one another in the retail environment. For example, the monitor may be a radio frequency identification (RFID) reader operating to read RFID tags. Depending on the selected type and frequency of RFID tag utilized, a defined zone may extend outward from 0.1 to 15 meters from a zone manger. Alternatively, the monitor may be a RuBee reader operating to read RuBee tags. Other examples of potential monitoring technologies include any short range communication technology (e.g., NFC, Bluetooth) that allows the region manager to receive position information that is transmitted by the marker. In addition to detecting when a marker enters a corresponding region, each region manager 135 is able to detect when the marker leaves the region.

In addition to being able to detect when a marker enters and leaves a detection region, the region manager 135 is also able to detect a location of the marker within the region. For example, the region manager may use ultra wideband (UWB) radio sensors sold by Time Domain Corporation of Hunstsville, Ala. (timedomain.com) and designed to detect the location of PLUS asset tags within the retail environment. As another example, the region manager may be an RFID-radar™ system manufactured by Trolley Scan (Pty) Ltd of Johannesburg, South Africa. Such a system is able to detect the presence, angle, and distance of an RFID tag from a reader antenna. As another example, the marker may contain a component that is able to determine the marker's location by triangulation (or other location-calculation technique) on signals from local wireless networks, such as WiFi, WiMax, WLAN, or cellular network signals. Examples of such a system that allows triangulation based on local wireless network signals are manufactured and distributed by AeroScout of Redwood City, Calif., Ekahau of Reston, Va., and Metrix Communication LLC of Seattle, Wash. As still another example, the marker may contain an assisted global positioning system (A-GPS) module that allows the marker to determine its location from A-GPS signals. The marker may then transmit the position to the region manager on a periodic or aperiodic basis via a short range communication protocol. Such a system to enable the detection and use of GPS signals in a retail environment is manufactured and distributed by u-blox AG of Switzerland or Alanco of Scottsdale, Ariz. While the location accuracy of the disclosed systems varies, the systems typically allow the location of a marker to be detected with sub-meter accuracy.

Within each detection region 205 are one or more display device devices 125. As previously noted, the display devices are capable of presenting advertising content to consumers. Display devices 125 may be low power devices, such as e-ink displays, e-paper displays, or cellular telephone displays that are capable of operating on a self-contained power source such as a rechargeable battery. Alternatively, display devices may be higher-power displays, such as LCD, LED, OLED, QLED, or any other display technology, that requires connection to a power supply in the retail environment. For example, a display device that is suitable for use in the system is a mobile internet device (MID) manufactured by Greenway International Group Limited, of Guangdong, China, such as model MID-M702R having a resistive touchscreen, built-in WiFi, and ARM11 processor.

Each region manager 135 maintains records of the number and location of the display devices 125 that are contained in the detection region monitored by the region manager. The region manager 135 also maintains records of the display zones, including the relative size and position of the display zone with respect to the corresponding display and the detection region. The location of the display devices and zones may be stored in a data storage area, and updated on a periodic or aperiodic basis by the session manager. For example, the session manager may distribute a new mapping of display zones to detection regions when the owner of a retail environment changes the layout of shelving units, when display devices are repositioned on the shelving units, when changes are made to the type of installed display device, etc.

By maintaining a record of the size and position of each display zone within the detection region, and then tracking the location of each marker as it moves within the detection region, the region manager 135 is able to detect when a marker enters and leaves a display zone of a display device. The region manager does so by comparing the current location of a marker with the locations of display zones in a detection region in order to determine whether the current location indicates that the marker has entered, remains inside, or has exited the display zone.

The region managers 135 are coupled to a session manager 215 via a wired or wireless connection. When a region manager 135 detects a new marker 210 entering a detection region 205 that the region manager is monitoring, the region manager generates and transmits a message to the session manager 215. The message contains a marker identifier (a “marker ID”) and a detection region identifier (a “region ID”) to notify the session manager of the presence of the marker within the detection region. When the region manager 135 subsequently detects that the marker has entered a display zone 212 that is within the detection region 205, the region manager 135 generates and transmits a hypertext transfer protocol (HTTP) request to the session manager 215. The HTTP request contains the marker ID and a display zone identifier (a “zone ID”) to notify the session manager of the presence of the marker within the display zone. The HTTP request also serves as a request for the session manager to provide advertising content for presentation on the corresponding display device 125 that is contained within the display zone.

When it receives an HTTP request from a region manager 135, the session manager 215 identifies and delivers relevant advertising content to the appropriate display device 125 for presentation to the consumer. The advertising content is targeted to the consumer based on a variety of factors, including the display zone in which the consumer is located (and the corresponding product, groups of products, or categories of products associated with that zone), past indications of interest in a particular product or category of products, past purchases, and any other known or predicted information about that consumer.

To enable targeting of advertising content, the session manager 215 is coupled to a number of databases that store information about the display zone and consumer. The session manager 215 is coupled to a zone mapping database 218, which contains information about each of the display zones in the retail environment. The zone mapping database 218 may contain, for example, for each display zone: (i) information about the location of the zone in the retail environment; (ii) the type of the display device 125 (e.g., screen size, graphics capabilities, type of consumer controls); (iii) an address of the display device so that advertising content may be directed to the display device; and (iv) an identification of the product, products, or categories of products within or associated with the display zone. The zone mapping database 218 is indexed via the zone identifier (zone ID), which uniquely identifies each display zone within a particular retail establishment. The session manager 215 is also coupled to a consumer profile database 220, which maintains various information about any consumers that are capable of being tracked across multiple visits to the retail environment (e.g., customers who have opted to allow the store to maintain records on shopping behavior, such as by joining a store loyalty program). The consumer profile database 220 may contain, for example, for each consumer: (i) the marker ID associated with the consumer; (ii) any demographic information that is known or predicted about the consumer, such as the gender, ethnicity, age, or income bracket of the consumer; (iii) a record of past purchases and purchase behavior of the consumer; (iv) a record of one or more loyalty programs in which the consumer participates; (v) a record of accumulated points or awards in the one or more loyalty programs; and (vi) an address or other connection information of a mobile device associated with the marker ID. The consumer profile database 220 is indexed via the marker ID that is associated with each consumer (e.g., via a marker ID associated with a store loyalty card that is held by a consumer, via a marker ID that is associated with a mobile device of a consumer). The session manager 215 is also coupled to a session database 225. The session database 225 maintains a record of all region or zone events that are associated with a consumer during a visit to the retail environment. A region or zone event may be, for example, (i) the entry of the consumer into or exit from a detection region (as reflected by the detection of the marker associated with the consumer), (ii) the entry of the consumer into or exit from a display zone (as reflected by a determination that the location of the marker within the detection region places the marker within the display zone); (iii) the presentation of an advertisement to the consumer in a display zone; (iv) an action of the consumer taken with respect to a display device, such as a request for an additional advertisement or the selection of a coupon; (v) the redemption of a coupon during the checkout process; and (vi) any other details of the checkout process (e.g., the payment instrument, the identity of products purchased or returned, etc.). A set of region and zone events associated with a consumer's visit is referred to herein as a session log, and may be stored or deleted following the consumer's visit. Such a session log may begin, for example, when a shopping cart leaves a shopping cart holding area or when a new marker is first detected within the retail environment. The session log may end when the marker is detected at a check-out area, or when a threshold period of time has elapsed without detecting a marker in a detection region thereby suggesting that the marker has left the retail establishment. The session database 225 is typically indexed by marker ID, region ID, zone ID, session ID, or any of the other fields that are maintained in the session database.

To further enable delivery of more relevant advertising content to a consumer, in some embodiments the session manager 215 may initiate one or more requests for information about the consumer that is associated with the marker. For example, if the marker is associated with a consumer's mobile device, the session manager may transmit a query to the mobile device to request that the mobile device provide additional information about the consumer. The address or other connection information for a consumer's mobile device may be stored, for example, in the consumer profile database 220 and indexed by the marker ID. The session manager 215 may transmit the query to the mobile device via a short-range wireless communication technology deployed in the retail establishment (e.g, via a Bluetooth network, WiFi network, active RFID, NFC etc.) or the session manager may transmit the query to the mobile device via a long-range wireless communication network (e.g., via a cellular network, via a WiMax network). When the query is received by the mobile device, the mobile device responds with consumer information that might be used to tailor advertisements for the consumer. The consumer information may include, for example, the consumer's product or brand preferences, coupons on the mobile device associated with products of interest to the consumer, a record of past purchases made by the consumer, a record of past online behavior of the consumer (e.g., a record of sites that were previously accessed by the consumer, content viewed, etc.), a record of the consumer's interests, a record of products for which the consumer has previously indicated an interest, an identification of one or more loyalty programs in which the consumer participates, a record of accumulated points or awards in the one or more loyalty programs, or any other information that characterizes the consumer. Information received from the mobile device may be used by the session manager 215 to further select the advertising content that is to be delivered to the consumer. In some embodiments, consumers are given the option of determining how much, if any, information from the mobile device is shared with the session manager 215. A consumer may have the option, for example, of limiting the shared information to certain classes of information (e.g., only to coupons that are stored on the mobile device, only to demographic information stored on the mobile device), to attach certain temporal limitations to the shared information (e.g., to only share information that was added to the mobile device within the past week), or to disable the sharing of any information. The consumer may set limits on the shared information during a registration process (e.g., during the registration for a loyalty program associated with the retail environment), via an interface on the mobile device, or via a system interface accessed via the World Wide Web. In addition to using the received information to determine current advertising content that is delivered to the consumer, the information received from the mobile device may be stored by the session manager 215 in the consumer profile database 220 and used to tailor advertising content that is delivered during subsequent visits of the consumer to the retail establishment.

As will be described in additional detail herein, data obtained by the session manager 215 from the zone mapping database 218, the consumer profile database 220, the session database 225, and from a mobile device in response to any requests for information are utilized to select the advertising content to present to consumers within the identified display zone. The session manager 215 is coupled to a local ad storage area 230 which contains advertising content that is associated with the products or categories of products that are available at the retail establishment. Based on multiple factors, including without limitation the stored display zone and consumer information, the session manager 215 selects one or more advertisements for presentation to the consumer. The session manager 215 then transmits the selected advertising content to the appropriate display device 125 via an HTTP response. The session manager 215 is able to send messages to, and receive messages from, display devices 125 within each detection region using a wired or wireless protocol. For example, a session manager 215 may communicate with a display device 125 using WiFi or another wireless communication protocol. As another example, a session manager may communicate with a display device across a wired network. As will be described herein, the session manager 215 coordinates the presentation of the received advertising content to consumers via the display devices 125.

The advertising content that is stored in the local ad storage area 230 may be periodically updated by the session manager 215. The session manager is coupled via a public or private network 235 to an advertising aggregator 240. The advertising aggregator 240 periodically accesses or crawls remote services 205a, 250b, . . . 250n to identify advertising content that may be presented to consumers. The remote services may be Internet advertising syndicators (e.g., Google, Microsoft, AOL, etc.), advertising agencies or agents (e.g., WPP or RazorFish), or manufacturers of products or providers of services (e.g., Johnson & Johnson, Proctor and Gamble, General Mills, Coleman, etc.). Advertising content that is identified by the advertising aggregator 240 is stored in a remote ad storage area 245. On a periodic basis, the advertising aggregator 240 transmits new advertising content to the session manager 215 to replace or supplement existing advertising content that is contained in the local ad storage area 230. Advertising content in the local ad storage area may be removed when the content has expired or when the performance of the advertising content falls below a threshold performance level. In addition, the advertising aggregator 240 may compare the performance of advertising content stored in the local ad storage area 230 and being used by the session manager 215 with the anticipated performance of new advertising content stored in the remote ad storage area 245. If the new advertising content is expected to perform better (as measured by, for example, conversion or revenue payable to the operator of the system 200) than the advertising aggregator 240 transmits new advertising content to replace some or all of the advertising content. The analysis of the performance of advertising content may be performed on a periodic (e.g., daily, weekly, monthly) or aperiodic (e.g., when new advertising content is obtained) basis.

In addition to managing the delivery of advertising content via HTTP responses to the display devices, the session manager 215 also maintains a session log that is associated with each marker 210 that is present within the retail environment. Each session log is a record of all region or zone events that are associated with the corresponding marker during a defined timeframe (typically measured as a shopping session or a consumer's visit to the retail establishment). As a marker 210 is carried through the retail environment by a consumer, the session manager 215 maintains a record of all detection region and display zone events that are associated with the marker. For example, the session manager 215 stores a record of the marker's entry into different detection regions, entry and exit into display zones within a region, exit from detection regions, and dwell times in each region or zone in the session log that is associated with the marker. In addition, the session manager 215 maintains a record of any advertising content that is presented on a display device 125 while the marker is present in the corresponding display zone. The session manager 215 also maintains a record of any consumer interactions with the display devices 125, such as requesting a coupon or requesting additional information about a product or category of product. Finally, the session manager 215 maintains a record of all check out or payment events associated with the marker, such as the purchase of particular products or the use of coupons or other offers during a payment process.

Those skilled in the art will appreciate that some or all communications between system 200 components and external services, and some or all of the data contained in the data storage areas, may be encrypted or otherwise secured to protect any confidential or other proprietary information that is managed or used by the system. For example, personally-identifiable information such as names, addresses, demographic information, etc. may be encrypted in order to minimize the likelihood that the data can be accessed by unauthorized third parties.

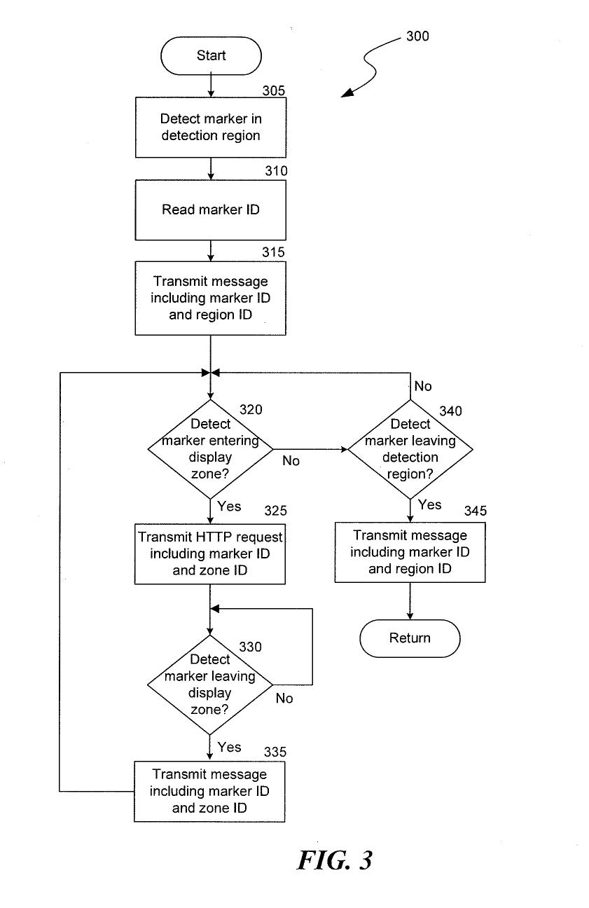

FIG. 3 is a flow diagram of a process 300 implemented by the region managers 135 to detect a detection region or display zone event associated with a consumer 105, and to generate an HTTP request for the delivery of relevant advertising content to a display device 125 in response to any display zone events. At a block 305, the region manager 135 detects a marker 210 in the detection region that is monitored by the region manager. The marker 210 may be detected by an active or passive sensor that detects the presence of the marker. For example, as previously discussed, if the marker is an RFID tag the region manager detects the presence of the RFID tag using an RFID reader. Since markers move through the store under the motive force of consumers, the detection of a marker signals to the region manager 135 the likely presence of a consumer 105 within the region manager's region. (Exceptions might occur, for example, if a cart were to be pushed away from a consumer and travel into a detection region on its own. Such exceptions are a rarity, however, and in most cases are followed by a consumer entering the detection region to retrieve the cart.)

At a block 310, the region manager 135 reads an identifier associated with the marker. The marker ID is a reference number or other code that allows the system to uniquely identify the marker 210 and thereby track the movement of the marker (and, by implication, the associated consumer) throughout the retail environment. Such tracking is accomplished by detecting when a marker enters a region or zone and when a marker leaves the region or zone. The series of region and zone detection events allows the session manager 215 to maintain an accurate record of the regions and zones visited by the consumer during a particular session. Moreover, the speed of the consumer may be estimated by dividing the known region or zone size by the transit time that it took for the marker 210 to traverse the region or zone. By monitoring the direction and speed of the marker 210 though the regions and zones, it is possible for the session manager 215 to predict the likely next region or zone that the consumer will enter based on the path of the consumer.

At a block 315, the region manager 135 constructs a message that is to be sent to the session manager 215 to notify the manager that a marker 210 (and presumably, a corresponding consumer) has entered the detection region. The message contains a region ID, which indicates the detection region in which the marker 210 was detected, as well as the marker ID, which indicates the identity of the marker that was detected. In addition, the message may include the time that the marker was initially detected entering the region. It will be appreciated that a greater or lesser amount of information may be contained in the initial message to the session manager.

Once the marker 210 has entered the detection region, the region manager 135 monitors the location of the marker 210 within the region to determine whether the marker enters a display zone within the region or whether the marker leaves the detection region. (Depending on the configuration of the detection region and the one or more display zones within the detection region, a marker may or may not pass through a display zone before leaving the detection region.) At a decision block 320, the region manager determines whether the marker has entered a display zone, and at a decision block 340, the region manager determines whether the marker has left the detection region. The region manager does so by comparing the current location of the marker with the locations of display zones in the detection region in order to determine whether the current marker location indicates that the marker falls within a display zone. If the test at decision block 320 indicates that the marker has entered a display zone, then processing continues to a block 325. At block 325, the region manager 135 transmits an HTTP request to the session manager 215 to request the delivery of advertising content to the display 125 that is contained in or associated with the display zone. The following is a representative format of an HTTP request constructed and transmitted by the region manager:
GET/path/script.cgi?marker_id=value1&display_zone_id=value2HTTP/1.1Host: www.visablebrands.com:80

The request contains a zone ID (value2), which indicates the display zone in which the marker 210 was detected, as well as the marker ID (value1), which indicates the identity of the marker that was detected. The Host address is the IP Address (or name) of the session manager. In addition, the HTTP request may include the time that the marker was initially detected entering the display zone. It will be appreciated that a greater or lesser amount of information may be contained in the HTTP request, depending on the amount of information that is required by the session manager 215 to identify advertising content for presentation to a consumer. An advantage of using a HTTP request is that it extends a protocol normally only used in the online world (i.e., in the networked computer environment), to the physical environment of brick-and-mortar stores. By utilizing requests formatted in accordance with the HTTP protocol, the region manager 135 is more easily integrated with pre-existing online services, such as advertising networks.

After transmission of the HTTP request for advertising content, processing continues to a block 330. At block 330, the region manager 135 monitors the location of the marker 210 to determine whether the marker has exited the display zone. When the marker has exited the display zone, processing continues to a block 335 where the region manager 135 sends an message to the session manager 215 to indicate to the session manager that the marker (and presumably the consumer) is no longer in the display zone. The message contains a marker ID, to indicate the identity of the marker, and the zone ID, to indicate the display zone that the marker just exited. In addition, the message may include the time that the marker was detected as leaving the display zone. It will be appreciated that a greater or lesser amount of information may be contained in the message to the session manager. When the marker 210 has left a display zone adjacent to display device 125, the likelihood that the consumer associated with the marker is still watching or listening to the advertising is substantially reduced.

After sending a message to the session manager 215 indicating that the marker has left the display zone, processing returns to decision blocks 320 and 340 where the region manager 135 continues to monitor the location of the marker to determine whether the marker re-enters the same display zone, enters a different display zone, or leaves the detection region. If at decision block 320 it is detected that the marker has re-entered the same display zone or entered a different display zone, the processing in blocks 325-335 is repeated. If, however, the region manager 135 determines that the marker has left the detection region in decision block 340, processing continues to block 345. At block 345, the region manager 135 sends a message to the session manager 215 to indicate to the session manager that the marker (and presumably the consumer) is no longer in the detection region. The message contains a marker ID, to indicate the identity of the marker, and the detection region ID, to indicate the detection region that the marker just exited. In addition, the message may include the time that the marker was detected as leaving the detection region. It will be appreciated that a greater or lesser amount of information may be contained in the message to the session manager.

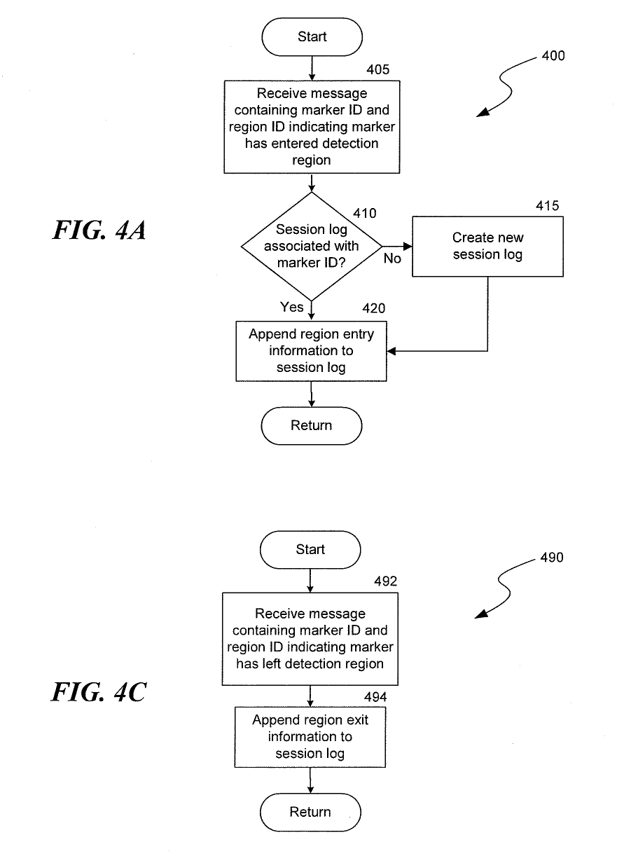

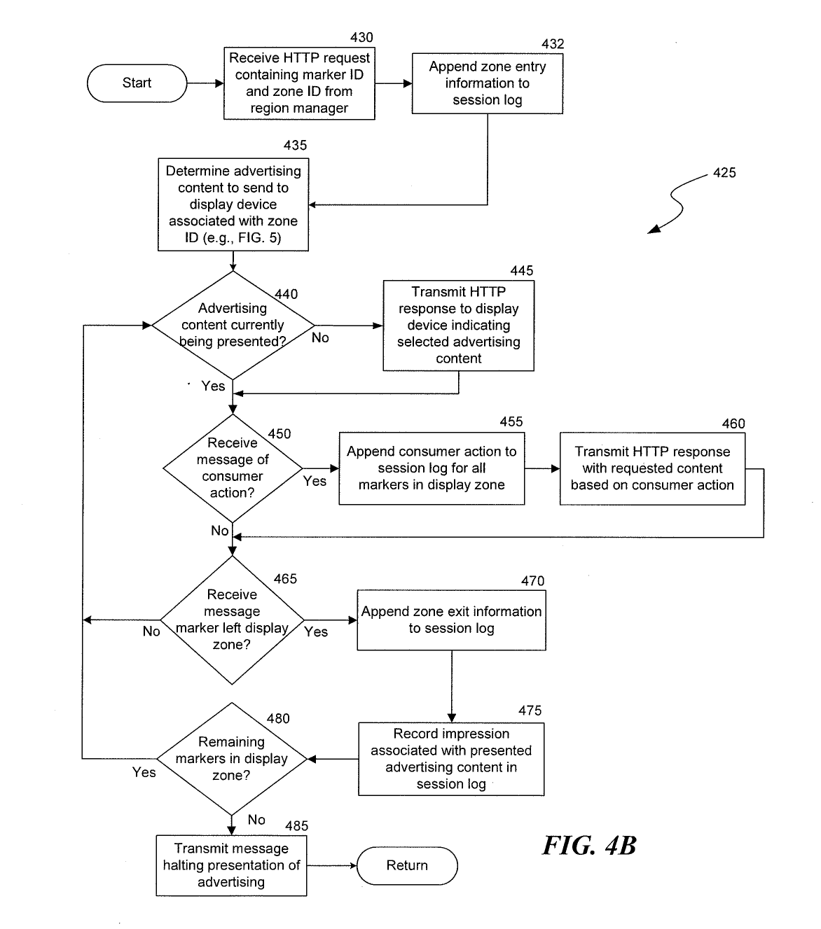

FIGS. 4A-4C are flow diagrams of processes implemented by the session manager 215 to receive and process region or zone events that are sent by the region manager 135. FIG. 4A is a flow diagram of a process 400 implemented by the session manager to receive and process a message indicating that a marker has entered a detection region monitored by the region manager 135. At a block 405, the session manager receives a message that contains the marker ID of the detected marker, as well as the region ID that identifies the region in which the marker was detected. At a decision block 410, the session manager 215 determines whether there is a session log associated with the received marker ID. If no session log is currently associated with the marker ID, at a block 415 the session manager 215 creates a new session log and assigns the session log to the received marker ID. If, however, a session log is already associated with the marker ID at decision block 410, processing continues to a block 420.

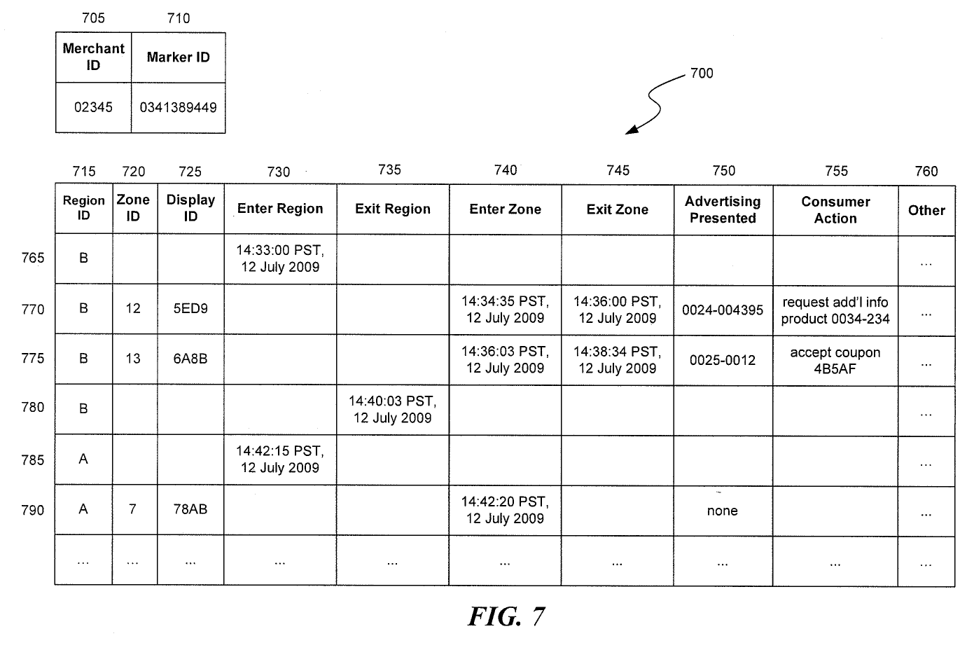

At block 420, the received region ID and other information is appended to the session log. The session log thereby contains a record of the region event, namely the initial detection of a particular marker in the region at a certain date and time. The construction and contents of the session log will be discussed in further detail herein with respect to FIG. 7. Once the region event reflecting entry of a marker into a region has been recorded in a session log, the process 400 is complete.

FIG. 4B is a flow diagram of a process 425 implemented by the session manager 215 to receive an HTTP request from the region manager 135, determine advertising content to present to the consumer, and transmit the advertising content to the appropriate display device 125 via an HTTP response. At a block 430, the session manager 215 receives an HTTP request for advertising content that is sent from a region manager 135. The HTTP request contains the marker ID of the detected marker, as well as the zone ID that identifies the zone in which the marker was detected. At block 432, the received zone ID and other information is appended to the session log. The session log thereby contains a record of the zone event, namely the entry of a particular marker into a display zone at a certain date and time. In addition, the session log contains a record of the zone ID, which allows the session manager to determine the one or more products or categories of products that are contained in or associated with the display zone. The construction and contents of the session log will be discussed in further detail herein with respect to FIG. 7.

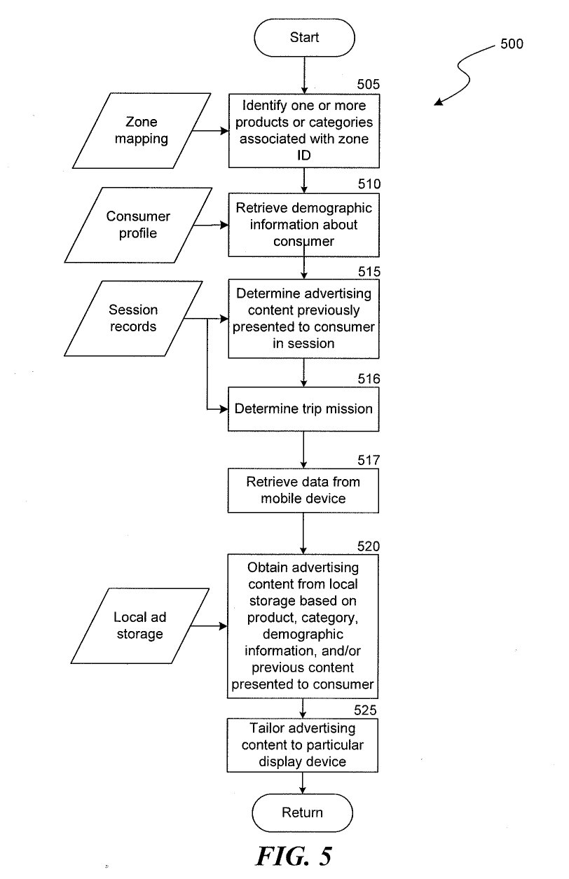

After appending the zone event to the session log, at a block 435 the session manager 215 determines the advertising content that is to be sent to a display device 125 for presentation to the consumer. To determine which advertising content to send to the display device, the session manager executes a selection process 500 such as is depicted in FIG. 5. FIG. 5 is a flow diagram of the process 500 to select relevant advertising content for presentation to the consumer based on the received HTTP request. At a block 505, using the received zone ID, the session manager 215 identifies one or more products or categories of products that are contained in or associated with the entered zone. The products or categories of products are identified from the zone mapping database 115 that is maintained by the session manager.

At a block 510, using the received marker ID, the session manager 215 retrieves any demographic information that is known about the consumer. The demographic information is contained in the consumer profile database 220 that is maintained by the session manager 215. If the marker ID is associated with a marker that is constantly being reused by different consumers, such as a marker that is attached to a shopping cart, it may not be possible for the session manager 215 to correlate the marker ID with the identity of a specific consumer. If, however, the marker ID is associated with a marker that is associated with only a single consumer or a small group of consumers, such as a marker that is embedded within a store loyalty card that is carried by one or more members of a family, then the session manager 215 is able to correlate the marker ID with the identity of the consumer and retrieve any demographic information about the consumer. The demographic information may contain, for example, the age, gender, income bracket, and other factors that characterize the consumer. The demographic information may have been obtained by the session manager as a result of, for example, an initial registration process that a consumer completes in order to obtain the store loyalty card. The loyalty card information may also be associated with the customer's past purchase history, including items purchased, payment methods used, etc.

In some embodiments, the session manager 215 may also be able to retrieve customer preferences or other information based on a customer's online profile. For example, a customer may pre-register product preferences with an online service that can be linked to the customer's marker ID. As part of the registration process, the customer may indicate particular product or brand preferences, which can then be stored together with the customer's profile. In some embodiments, the online service may also receive information on aspects of the customer's online shopping or browsing habits to infer additional information about the customer's preferences. Accordingly, in block 510, the session manager 215 may also communicate with the online service to retrieve available preference information. The link to online information is discussed in greater detail below with reference to FIG. 12.

At a block 515, using the received marker ID, the session manager 215 retrieves any session information that is associated with the marker. The session information may be a current session log that is associated with the marker. The current session log reflects all region and zone events associated with the current visit of the consumer to the retail establishment. For those marker IDs that are associated with the same consumer across more than one session, the session manager 215 may also retrieve past session logs. Past session logs represent prior visits by the consumer to the retail establishment, and are useful because they provide an aggregate record of shopping and purchasing behavior by the consumer.

At a block 516, the session manager 215 may also determine the trip mission for the current shopping trip. A trip mission is an estimate of the customer's goals for a particular shopping trip. That is, the trip mission characterizes the customer's relative priorities in balancing factors such as time, cost, and value for the shopping trip. From a retailer's perspective, these factors may translate to the amount of time that the customer expects to spend in the store and the amount of purchases that the customer makes during that period. Exemplary types of trip mission that are associated with the grocery industry include:
Quick Trip—A quick trip is a short shopping trip to pick up a small number of items. Quick trips are typically done to meet immediate needs (i.e., for the same day or the next day) and result in the customer purchasing only a few items. Customers on a quick trip prioritize time over money and tend to be less cost-conscious. They also tend to exhibit higher demand for premium products. Quick trips represent a high percentage of total store visits for grocery stores.
Partial Fill or Fill In—A partial fill or a fill in is a trip in which the customer wants to re-stock the pantry, fill routine needs for the next several days, or take advantage of special offers or sale prices. Fill in trips are larger than quick trips, but are still relatively targeted.
Major Stock Up—A major stock up is a large shopping trip in which the customer will bundle both short-term and long-term needs into a single trip. Such customers generally shop the whole store and fill their baskets. Customers tend to prepare the most for this type of trip and spend the most time in the store.

However, types of trip mission are not limited to those listed above. In particular, trip missions may be characterized based on different relative weightings of time, cost, value, or other factors. For example, in some cases, trip mission might be defined solely by the amount of time the customer intends to spend in the store. Under this definition, the system might provide for three types of trip missions corresponding to an estimate that the customer intends to spend less than 10 minutes for a short trip, between 10 and 50 minutes for a medium trip, and over 50 minutes for a long trip. In other cases, the trip mission may be characterized based on an estimate of the amount of money the customer expects to spend or an estimate of the customer's interest in value products or premium products.

As discussed in greater detail below, the session manager 215 may attempt to characterize the customer's trip mission by detecting patterns in the customer's movement throughout the store. These patterns may be detected using, for example, information stored in the session records data structure. The process of determining trip mission is discussed in greater detail below with reference to FIGS. 13A-C.

At a block 517, if the marker is associated with a mobile device the session manager 215 may retrieve information associated with the consumer from the mobile device. The information associated with the consumer may include, but is not limited to, the consumer's product or brand preferences, coupons on the device associated with products of interest to the consumer, a record of past purchases made by the consumer, a record of past online behavior of the consumer (e.g., a record of sites that were previously accessed, content viewed, etc.), a record of the consumer's interests, a record of the products or services for which the consumer has previously indicated interest, an identification of one or more loyalty programs in which the consumer participates, a record of accumulated points or awards in the one or more loyalty programs, or any other information that characterizes the consumer that might be maintained on the mobile device.

At a block 520, the session manager 215 utilizes the information about the products and categories of products in the zone, any consumer profile information, information about current and past zone events that are associated with the consumer, predicted type of trip mission by the customer, and other factors (e.g., the current calendar date, the current weather, current events that may influence buying behavior) to select one or more pieces of advertising content that are to be presented to the consumer. The advertising content is selected to be targeted to a potential purchase that the consumer might make inside or outside of the present zone. For example, if the consumer is in a grocery store and in an aisle where canned soup is being sold, the session manager 215 may select an advertisement for Campbell's tomato soup for presentation to the consumer. Alternatively, the session manager 215 may select a complementary product to soup to advertise, such as crackers. The selected advertisement may have a video element that is presented to the display, as well as a coupon that the consumer may select if they are interested in making a purchase of Campbell's soup. If the consumer has a tendency to linger in zones for extended periods (e.g., if the average dwell time of the associated marker 210 is long), then the session manager 215 may select multiple pieces of advertising content for presentation to the consumer.

Advertising content is typically selected by the session manager 215 from advertising content stored in the local ad storage area 230. Selecting advertising content from the local ad storage area is advantageous because there is low latency (i.e., the session manager does not need to wait for a response to an external service request), because the particular advertising content stored in the local ad storage area may be tailored to the particular retail establishment (e.g., advertising content may be selected that is targeted to the local demographic of consumers in different merchant stores), and because it allows the retail establishment to pre-empt national advertising campaigns with its own campaigns more easily. In some circumstances, however, there may be no advertising content that is stored locally that is suitable for presentation to consumers in a particular display zone. For example, advertising content stored in the local ad storage area may have expired and no recent updates may have been received from the advertising aggregator 240. As another example, there may have been no advertisements stored in the local ad storage area that pertain to the products associated with the display zone. In these and other circumstances, the session manager 215 may make a direct call to one or more advertising syndicators (e.g., Google, Microsoft, AOL, etc.), to advertising agencies or agents (e.g., WPP or RazorFish), or directly to manufacturers of products or services (e.g., Johnson & Johnson, Proctor and Gamble, General Mills, Coleman, etc.). The requested syndicator, agency, or advertiser may then reply in real-time or near real time with advertising that should be presented to consumers in the particular display zone. Because the initial request for advertising content that is received by the session manager 215 is formatted in accordance with the HTTP protocol, the request received from the region manager 135 may be directly forwarded to the advertising syndicator, agency or other ad provider with little or no required formatting changes. As a result, the system disclosed herein allows the brick and mortar environment to take advantage of the advertising content and brokering that has become so robust in the World Wide Web.

At a block 525 the session manager 215 may tailor the selected advertising content for the display device 125 on which the selected advertising content will be presented. In some circumstances, a retail establishment may utilize display devices having different technical characteristics and capabilities. For example, some display devices may have color screens while others may have black and white, some display devices may be optimized for the display of video while others may be optimized for the display of text, some display devices may have a speaker to allow sound to accompany advertising content while others may not have a speaker, etc. In other situations, the session manager may optimize the content for presentation on the particular display device. Such optimization may include selection of one format of advertising content over another if multiple formats are available, or may include transformation of the advertising content such as by changing the resolution of the advertising content.

Returning to FIG. 4B, after selection of the advertising content to transmit to the display device at block 435, processing continues to a decision block 440. At decision block 440, the session manager 215 determines whether any advertising content is currently playing on the display device 125 that is to receive the newly-selected advertising content. Because the region manager 135 transmits an HTTP request for advertising content each time that a new marker 210 is detected in a display zone, and because the session manager 215 responds by selecting new advertising content to present on the display device 125, it is possible that advertising content may already be playing on a display device when new advertising content is selected for transmission by the session manager. For example, if three consumers having markers all enter a display zone, the session manager will select at least three pieces of advertising content that are to be displayed on the display device in the display zone. To resolve such a scheduling conflict, the session manager 215 implements a FIFO algorithm, meaning that the selected piece of advertising content for the first detected marker is played and that the other pieces of advertising content are queued for presentation after the preceding pieces of advertising content are finished. If advertising content is therefore currently playing on the intended display device 125 at decision block 440, the session manager allows the currently playing piece of advertising content to continue to conclusion. If, however, no advertising content is currently playing on the display device 125 at decision block 440, processing continues to a block 445.

At block 445 the session manager 215 transmits an HTTP response to the display device 125 (i.e., the display device associated with the zone ID that was contained in the region manager's initial request for advertising content). The HTTP response contains the advertising content that was identified by the session manager 215 as being appropriate for presentation to the consumer in the zone. In some embodiments, rather than transmitting the advertising content, the session manager 215 transmits a link or other pointer to the advertising content so that that the display device 125 may retrieve the advertising content from the local ad storage area 230 directly.

In some embodiments, the session manager 215 may also transmit the HTTP response containing advertising content to other display devices 125 in addition to the display device this is associated with the display zone in which the marker 210 is detected. For example, in FIG. 1B, Region F contains three display devices 125 that are in proximity to each other. Certain advertisers may prefer that their advertising content run on all three display devices simultaneously, particularly if Region F covers a common product category. To allow the simultaneous display of advertising content on multiple display devices, the session manager maintains business rules that define groups of display devices and identifies the circumstances under which each group should be used. For example, all of the display devices 125 in Region F may be specified as being in a group so that the entry of a marker into any of the three display zones causes the same advertising content to be simultaneously presented on each display of the group. As another example, only certain advertisers may be willing to pay the increased advertising fees associated with presenting advertising content on more than one display device, so the business rules may specify which advertising content is only presented on one display device and which advertising content is presented on a group of display devices. The business rules allow the groups to be dynamically defined, modified, and deleted as specified by the system operator. When the same advertising content is to be displayed on multiple display devices, the session manager 215 merely transmits the same HTTP response containing the desired advertising content to the specified display devices.

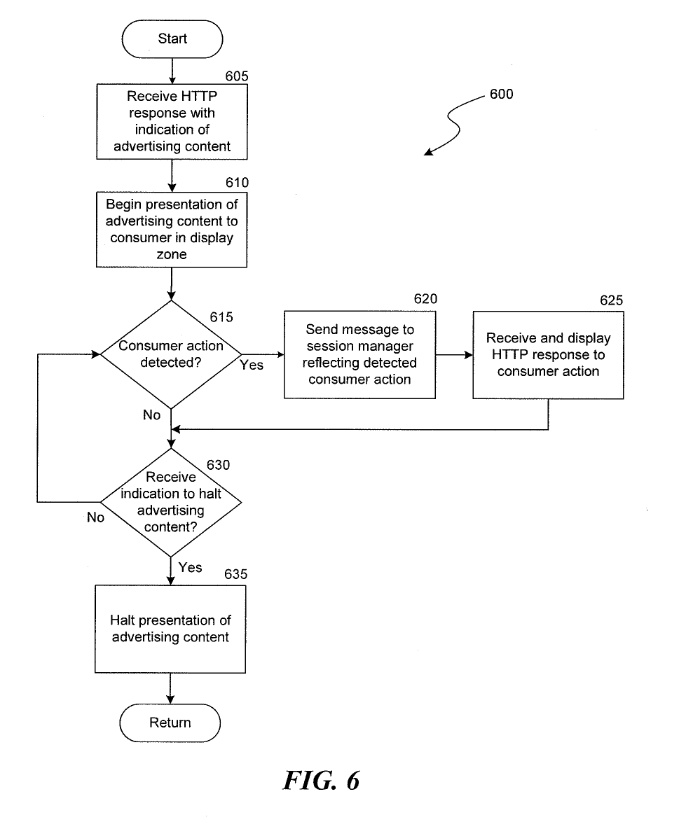

After the advertising content is transmitted to the display device 125 (or display devices), the advertising content is presented on the display device 125 (or devices). FIG. 6 is a flow diagram of a process 600 that is executed by a display device 125 to receive the HTTP response from the session manager 215 and present the selected advertising content to one or more consumers. At a block 605, the display device receives the HTTP response from the session manager 215 which includes the advertising content or a link to the advertising content that is to be presented. At a block 610 the display device begins to present the advertising content to any consumers that are presumed to be in the display zone by the existence of markers in the display zone.

As advertising content is being presented on the display device 125, the display device is checking to see if any consumer action is detected by the display device or if any further content or commands are received from the session manager 215. Such consumer action may be the selection of a button on the display device to accept a product offer (e.g., receive a coupon, select a 2-for-1 deal, receive a discount on a second product with the purchase of a first product, etc.), to see additional information about the displayed product, to request another advertisement, etc. At a decision block 615, the display device determines if a consumer action is detected such as, for example, by the selection of a button contained on the display device. If consumer action is detected at decision block 615, processing continues to a block 620. At block 620, the display device 125 sends a message to the session manager 215 to indicate that the detected consumer action. The message contains a description of the consumer action to allow the session manager to record the action in a session log. Because the consumer action is captured in the session log associated with the marker 210, the system 200 is able to take subsequent action on the recorded action, such as by redeeming a selected coupon during a checkout process or tailoring subsequent advertising based on an improved understanding of the consumer's interests. At a block 625, the display device receives an HTTP response from the session manager 215 which indicates that the consumer action has been recorded. The HTTP response may also include content to display to the consumer, such as a message indicating that a coupon has been recorded as being associated with the marker, or a message providing the additional information (e.g., recipes, related products, nutritional information) that was requested by the consumer action. At block 625, the display device therefore presents any provided content to consumers in the display zone. Processing then continues to a decision block 630.

In addition to constantly checking to see if any consumer action is detected by the display device 125, the display device continues to receive and act on commands from the session manager 215. One of the commands that the display device implements is to halt the presentation of advertising content. The advertising content may be halted, for example, when the region manager 135 determines that all markers have left the display zone that is associated with the display device. At decision block 630, the display device determines whether a command has been received from the session manager 215 to halt the display of advertising content. If a command has not been received, processing continues to decision block 615 where the display device again determines whether a consumer action has been detected. If a command to halt advertising content has been received, processing continues to block 635 where the display device halts the advertising content that is currently being presented. After the advertising content is halted, the display device returns to a quiescent state where it waits to receive new advertising content for display to consumers.

Returning to FIG. 4B, after transmitting advertising content to a display device for presentation to consumers, the session manager 215 enters a monitoring state where it receives indications of consumer actions from the display device 125 that is presenting the advertising content, or indications of a further event associated with the corresponding display zone from the region manager 135. At a decision block 450, the session manager checks to see whether it has received a message indicating that a consumer action has been detected by the display device. If a message has been received processing continues to a block 455. Otherwise, processing continues to decision block 465.

At block 455, the session manager 215 appends the indicated consumer action to the session log of each marker 210 that is currently present in the display zone. In those situations where only a single marker is contained in the display zone, the session manager may reasonably assume that the consumer action was made by the consumer associated with the single marker. Multiple markers in the display zone, however, imply the presence of multiple consumers in the zone. In those situations where multiple markers are present in the display zone, it may be impossible for the display device to detect which particular consumer is associated with the action because of monitoring limitations of the display device. In such situations, the consumer input is recorded by the session manager 215 as being associated with all markers in the zone. That is, the consumer action is appended by the session manager onto a session log associated with each marker in the zone. Although some inaccuracy in recording consumer action results from this approximation, it ensures that the consumer that actually performed the action is appropriately recorded as having done so. In addition to recording the received consumer action in the appropriate session log, at a block 460 the session manager 215 transmits an HTTP response to the display device containing any requested content that is responsive to the detected consumer action. Processing then continues to decision block 465.

At decision block 465, the session manager 215 determines whether a message has been received from the region manager 135 that indicates that a marker 210 that was formerly in the display zone has now left the zone. The message includes the marker ID so that the session manager is apprised of the identity of the marker. Much as the region manager 135 is able to determine when a new marker enters the display zone, the region manager monitors the location of markers in the detection region in order to determine when a marker leaves the display zone. To perform such monitoring, the region manager 135 may periodically detect or compute the position of each marker to ensure that it continues to remain within the boundaries of the display zone. If the session manager does not receive an indication that a marker has left the display zone (i.e., all markers remain in the display zone), then processing returns to decision block 440 where the session manager determines whether new advertising content needs to be sent to the display device. If, however, the session manager receives an indication that a marker has left the display zone at decision block 465, processing continues to block 470. At block 470, an indication that the marker has left the display zone is recorded in the session log. By recording when the marker has left the display zone, the session manager is able to compute the marker's dwell time in the display zone by subtracting the entry time of the marker into the display zone from the exit time. The dwell time in the display zone may be used by the session manager to compute the speed of the marker by dividing the width of the transited zone by the dwell time.

After recording that the marker has left the display zone at block 470, at a block 475 the session manager records an impression in the session log indicating that the consumer associated with the marker was exposed to advertising content. If advertising content is presented on a display device when a consumer is in a display zone, it is likely that the consumer is exposed to the advertising content. The system therefore records an impression of the presented advertising content so that the advertiser may be charged for the impression. The impression recorded in the session log includes an indication of the advertising content that was presented to the consumer, since the session manager 215 tracks the advertising content that was sent to the display device for presentation to consumers. When an impression of the advertising content has been recorded in the session log, processing continues to decision block 480.

As an alternative to automatically recording an impression when a consumer is in a display zone and advertising is presented on the display device, the session manager 215 may instead condition the recordation of an impression on whether the marker has exceeded a threshold dwell time in the zone. If a marker transits a display zone too quickly, it might imply that the consumer associated with the marker was in a hurry or was interested in areas of the retail environment other than the area containing the zone. In such a case, it is unlikely that the consumer either would have been interested in the presented advertising content or would have been exposed to a sufficient amount of the presented advertising content to make an impression on the consumer. If, however, a consumer lingers in a display zone, it is likely that the consumer would have been exposed to the advertising content since the advertising content was presented while the consumer was actively shopping in that zone. While the threshold dwell time may vary widely depending on the size of the display zone and the identity of the products or categories of products associated with the zone, a threshold dwell time of four or five seconds may be the minimum period for an impression to be made. In an alternate implementation, if the transit time of the marker exceeds the threshold dwell time, the session manager records an impression in the session log associated with the marker since the consumer was likely exposed to the advertising content. In contrast, if the transit time of the marker does not exceed the threshold dwell time, the session manager does not record an impression of any advertising content in the session log, since the consumer did not dwell within the display zone for a sufficient period of time. It will be appreciated that the threshold dwell time may be adjusted by the session manager depending on the average length of the advertising content that is presented to consumers or the desired dwell time that an advertiser would prefer to see before an advertising impression is recorded.

At decision block 480, the session manager 215 determines whether any other markers 210 (and hence consumers) remain in the zone. If markers remain in the zone, processing returns to decision block 440 where a decision is made as to the advertising content that should be presented to the consumers. If, however, it is determined that no markers remain in the zone at decision block 480, processing continues to block 485. At block 485, the session manager 215 halts the presentation of advertising content on the display device 125. With no markers present, it is unnecessary to continue to present advertising content to an empty zone. Halting the display of advertising content also “resets” the display so that it is ready to present new advertising content when a new marker is detected as having entered a zone.

FIG. 4C is a flow diagram of a process 490 implemented by the session manager 215 to receive and process a message indicating that a marker has exited a detection region monitored by a region manager 135. At a block 492, the session manager receives a message that contains the marker ID of the detected marker, as well as the region ID that identifies the region that the marker just exited. At block 494, the received region ID and other information is appended to the session log. The session log thereby contains a record of the region event, namely the exit of the marker from the region at a certain date and time. Once the region event reflecting exit of a marker from the region has been recorded in a session log, the process 490 is complete. By recording both the entry time of a marker into a region and the exit time of a marker from the region, the session manager is able to calculate dwell time and rate of travel through any region in the retail establishment.

The session manager 215 stops recording events in the session log and “closes” the session log when it detects a condition that indicates the end of the consumer's visit to the retail establishment. For example, the detected condition may be the presence of the marker in a region that is associated with a checkout area. As another example, the detected condition may be a lengthy presence of the marker in a single region, such as might occur if a consumer abandons a shopping cart and exits a retail establishment. As yet anther example, the detected condition may be a purchase action by the consumer (e.g., the tendering of a credit card to pay for purchases) at the retail establishment. When such a condition is detected, the session manager may record a terminal event indicating the end of the session. If the marker is associated with a unique consumer, the session log may then be stored for that consumer. If the marker is not associated with a unique consumer, the session log may be stored in a fashion that allows aggregate analysis of the session log with other anonymous consumers.

In summary, the session manager 215 receives a number of different types of region and zone event notifications from region managers 135 and display devices 125 within a retail establishment. The session manager 215 receives messages from the region manager 135 indicating then a marker has entered and exited a region. The session manager 215 receives an HTTP request when a marker has entered a display zone and a message when the marker has exited the display zone. The session manager also receives one or more messages from display devices 125 indicating consumer actions that were received on a display device 125. All such requests and messages are typically received asynchronously from the region managers and display devices throughout the retail establishment as events are detected. Each of the received events will typically result in event data being appended by the session manager 215 to the appropriate session log. In this fashion, the session manager maintains an accurate record of all events that occur in the retail establishment and allows subsequent mining of the session logs to improve advertising effectiveness.

FIG. 7 is a representative session log 700 for storing session data associated with the region and zone events of a consumer. Each row in the session log 700 reflects one or more events that are associated with a marker 210. Each column in the session log 700 reflects one or more details of the event that is being tracked. All session logs are associated with a particular merchant and a particular marker. A “merchant ID” field 705 contains an identification number (“02345”) that uniquely identifies the retail environment that contains the zone. A “marker ID” field 710 contains the identification number of the marker that is being tracked. The first three columns of the session log 700 contain information that pinpoints the location of the marker. A “region ID” column 715 contains an identifier (e.g., region “B”) that uniquely identifies the detection region within the particular retail environment. A “zone ID” column 720 contains an identifier (e.g., zone “12”) that uniquely identifies the display zone within the particular retail environment. And a “display ID” column 725 contains an identifier (e.g., “5ED9”) that uniquely identifies each display device. The first three columns of the session log thereby allow the session manager 215 to track within an advertising network where a particular event takes place.

The next four columns of the session log 700 contain information that characterizes the marker's transit of a region or a zone. An “enter region” column 730 contains a time and date stamp that reflects when the marker ID was first detected in the identified region. An “exit region” column 735 contains a time and data stamp that reflects when the marker ID was detected has having exited the region. An “enter zone” column 740 contains a time and date stamp that reflects when the marker ID was first detected in the identified zone. An “exit zone” column 745 contains a time and data stamp that reflects when the marker ID was detected has having exited the zone. It will be appreciated that a region dwell time or a zone dwell time may be calculated by subtracting the appropriate enter time from the exit time, or may be determined by a timer that is started and stopped by a session manager.

The remaining columns of the session log 700 contain information that characterizes activities that occur within a display zone. An “advertising presented” column 750 contains a record of all advertising content that was presented while a marker 210 was within the identified display zone. The “advertising presented” column may also contain a record of advertising presented to the consumer that resulted in the consumer indicating interest. Advertising content is identified by a unique reference (e.g., “0024-004395”) so that the session manager is able to track the performance of particular pieces of advertising content across multiple session logs. As was discussed with respect to FIG. 6, an impression of the advertising content is recorded if the marker is in the display zone when the advertising content is presented on the associated display device. While it is common for only a single piece of advertising content to be presented to a consumer in a zone, if a consumer dwells within a zone for an extended period, two or more pieces of advertising content may be identified in the advertising presented column 750. In some circumstances, of course, no advertising content may be presented in a particular display zone, such as when no advertising content is available for presentation in the zone. A “consumer action” column 755 records any consumer actions that are capable of being captured by a display device. For example, the consumer action column may contain an indication of an offer that the consumer selected (e.g., “accept coupon 4B5AF”) or a request for additional product information that is made by the consumer. Of course, additional columns 760 may be added to the session log 700 by the session manager to support additional data that the system finds it useful to track.

Various region and zone events are depicted as being stored in the session log 700 of FIG. 7. For example, row 765 is a region entry event, since it contains an identifier of a region and a time of region entry. Row 770 reflects several display zone events, including the entry into a display zone (display zone 12), the presentation of an advertisement to the consumer, the recordation of a consumer action, and the exit from the display zone. Row 775 reflects several display zone events in a different display zone (display zone 13) as that reflected by row 770, but within the same region (region B). Row 780 reflects a region exit event, since it contains an identifier of a region and a time of region exit. Row 785 reflects a region entry event into a different region (region A). And row 790 reflects display zone events within a display zone (display zone 7) of the different region.

Those skilled in the art will appreciate that the system 200, session manager 215, and region managers 135 may be implemented on any computing system or device. Suitable computing systems or devices include personal computers, server computers, hand-held or laptop devices, multiprocessor systems, microprocessor-based systems, programmable consumer electronics, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

Although the region manager 135 and display 125 were introduced and discussed herein as being separate components, it will be appreciated that the region manager and display may be combined into a single unit. When combined into a single unit, the detection region and the display zone may cover the same area. In other words, the area that is monitored by the region manager 135 may be coincident with the area in which a consumer is likely to see a piece of advertising content that is presented to the consumer on the display device.

Although the various components in the system 200 were described as transmitting and receiving requests and responses using the HTTP protocol, it will be appreciated that in certain implementations a mobile messaging protocol may be used for messaging in lieu of the HTTP protocol. For example, the region manager 135, session manager 215, and display devices 125 may exchange communications using messaging formatted in accordance with a short message service (SMS) protocol, an ICQ (instant messaging) protocol, or a similar protocol. In such embodiments, each of the components of the system includes appropriate communication modules to enable messaging in accordance with the selected protocol. By using requests and responses formatted in accordance with common messaging protocols, the disclosed system may easily integrate with existing advertising services or content that are available via mobile messaging platforms

Those skilled in the art will also appreciate that the actual implementation of each database may take a variety of forms, and the phrase “database” is used herein in the generic sense to refer to any area that allows data to be stored in a structured and accessible fashion using such applications or constructs as relational databases, object databases tables, flat files, linked lists, arrays, and so on. Those skilled in the art will further appreciate that the depicted flow charts may be altered in a variety of ways. For example, the order of the steps may be rearranged, steps may be performed in parallel, steps may be omitted, or other steps may be included. While FIGS. 7 depicts a session log whose contents and organization are designed to make them more comprehensible by a human reader, those skilled in the art will appreciate that the actual data structure(s) used by the system to store this information may differ from the log shown, in that it, for example, may be organized in a different manner, may contain more or less information than shown, may be compressed and/or encrypted, and may be optimized in a variety of ways.

It will further be appreciated that the method of receiving information from a mobile device about a consumer may vary depending on the capabilities of the mobile device. For example, some mobile devices may offer the ability to periodically transmit (or “push”) information to the session manager 215 so that the session manager could use the information to tailor advertisements. If a push of information automatically occurs on a periodic basis, the session manager would not necessarily need to transmit a query to a mobile device to initiate such a transfer. It will also further be appreciated that the method of displaying information on a mobile device may vary depending on the capabilities of the mobile device. For example, screen shape, size, and color capabilities may vary between mobile phone models and may affect the performance of the mobile device's utility as a display device.

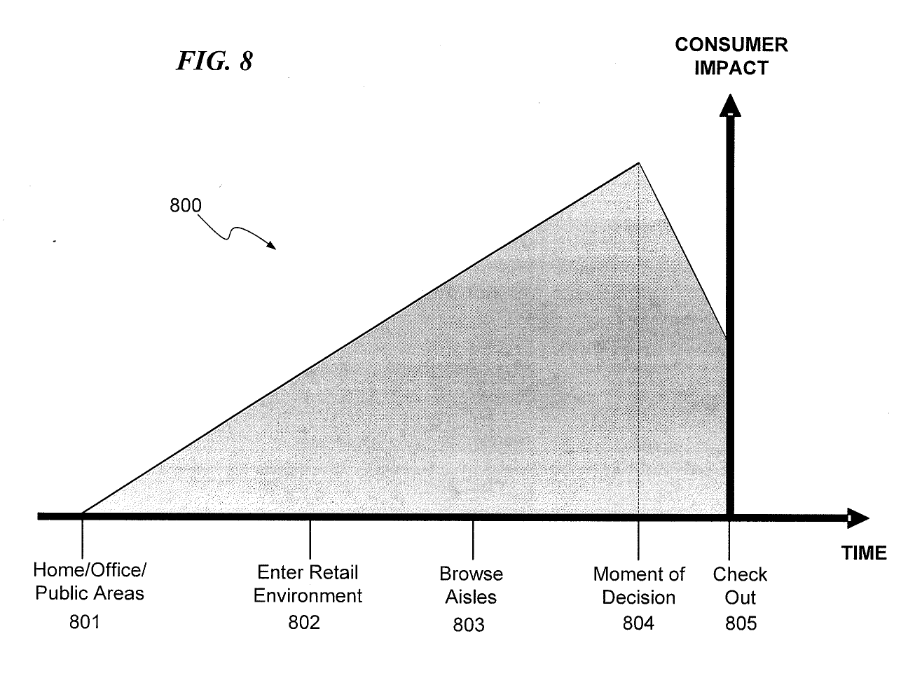

FIG. 8 is a graph 800 that represents a timeline of events and an approximation of the relative effectiveness of advertising presented during those events by an advertising system, from the time a first piece of advertising content is presented to a consumer through a point of purchase. In general, consumers are exposed to a large number of advertisements before they ever enter a retail environment. For example, an event 801 on the timeline represents the presentation of advertising content to a consumer at the consumer's home, office, in public, or other location outside of the retail environment. The overall effectiveness of the advertising presented at event 801 is quite low, meaning that although a consumer is exposed to many advertisements, it is unlikely that the consumer will purchase any particular advertised product or service. Advertising outside of the retail environment is unlikely to have a significant impact on a consumer because the advertising must compete with the consumer's other attentions, for example working, spending time with family, preparing meals, or engaging in other recreation. Moreover, the significant number of advertisements that are presented to consumers in their daily life means that any individual advertisement presented to a consumer has a difficult time making an impression.

As a consumer gets closer to a point of purchase, however, advertising content presented to the consumer has an increased effectiveness. For example, at an event 802, the consumer enters the retail environment. After entering the retail environment, advertising content presented to the consumer is typically more effective than advertising content presented outside of the retail environment. Presenting advertising content to the consumer at event 802 is more effective than presenting advertising content at event 801 because the consumer is physically closer to the products being advertised and temporally closer to the moment of decision. Therefore, the consumer is more likely to remember the advertising content and take action. Furthermore, the consumer is more likely to pay attention to advertising content because he or she is actively engaged in the shopping experience. Presenting advertising content to the consumer upon entry into the retail environment allows the retailer to set the tone for the shopping experience so that the consumer begins shopping with the advertised product or products already in mind.

An event 803 represents the active browsing of a consumer in the aisles of the retail establishment to shop for products or services. At event 803, advertising can be presented to the consumer that relates directly to products or services that are nearby the consumer. The graph in FIG. 8 illustrates the increased effectiveness of advertising content presented to consumers in the aisles of the retail establishment as compared to advertising content that is presented to consumers upon entering the retail establishment. The effectiveness of advertising content at event 803 is greater than the effectiveness of advertising content at event 802 because the user is physically closer to the advertised products and temporally closer to the moment of decision.

The consumer selects the desired product or service for purchase at an event 804 (the “moment of decision”). As illustrated in FIG. 8, event 804 is the most effective time to present advertising to the consumer. Here, the consumer is about to commit to a product or service and has expressed an intent to purchase the product. During a typical shopping session, the time around event 804 represents the retailer's last significant opportunity to influence the consumer's purchasing decision. If the retailer's advertising has been effective up to and including event 804, the consumer likely will purchase the product or products and exit the retail environment without reconsidering product choices or being distracted by other attentions. For example, rarely do consumers return products to a shelf after selecting the product and adding it to their basket, cart, or other carrying container. After event 804, the likelihood of changing the consumer's purchase behavior is reduced as evidenced by the downward slope of the line following event 804 as the consumer gets closer to the time of purchase.

At event 805, the consumer purchases the selected goods or services. Payment may be made by the consumer, for example, at a checkout register or payment kiosk. While some consumers may be swayed by advertising at the point of checkout, most consumers have committed to the purchase at this point and are unlikely to select a different product even if they view other advertising. As a result, as depicted in FIG. 8, the impact of consumer advertising at checkout is lower than the impact of consumer advertising at the moment of decision. Although FIG. 8 shows a linear relationship between time and effectiveness, it will be appreciated that the relationship between time and effectiveness may vary in a non-linear fashion. The consumer impact of advertising content, however, is typically highest at or near the moment of decision.

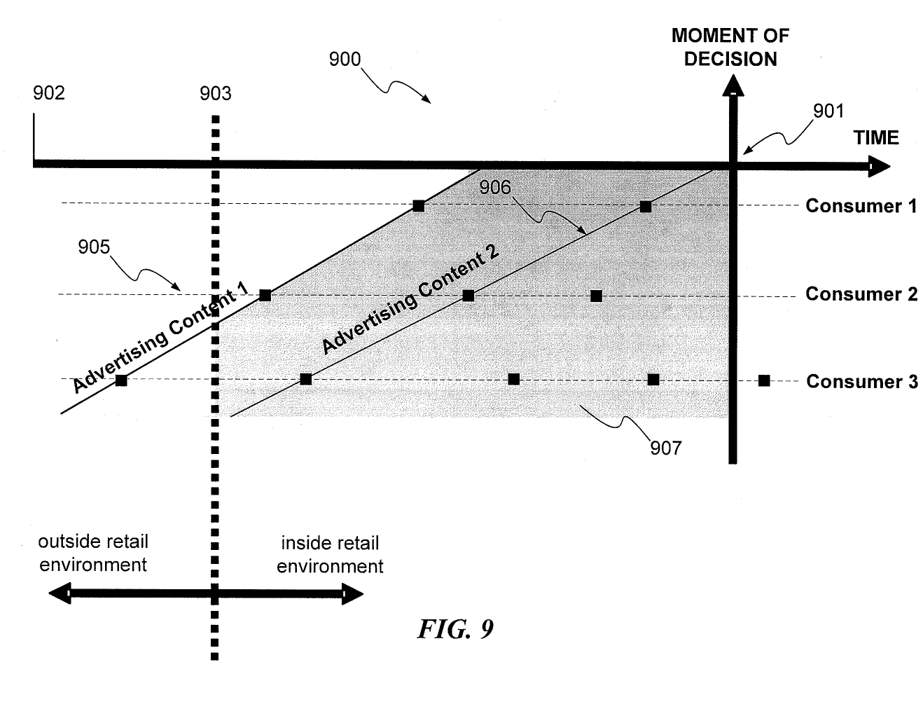

FIG. 9 is a graph 900 that represents the timing of advertising content presented to different consumers by the disclosed system. The horizontal axis represents the time of the presented advertising content, up until a moment of decision 901 by the consumer. The moment of decision 901 represents the selection of the product or service for purchase, prior to or concurrently with the financial transaction that results in the purchase of the product or service. The portion of the horizontal axis lying between points 902 and 903 represents the period of time in which the consumer is outside of the retail environment in which products or services are purchased. The portion of the horizontal axis lying between points 903 and 901 represents the period of time during which the consumer is located within the retail environment, from the point of entry into the retail establishment through the moment of decision within the retail establishment.

In the depicted graph, all users are presented with a first piece of advertising content 905. As depicted in FIG. 9, the first piece of advertising content 905 may be received by the consumer when the consumer is either outside or inside of the retail environment. For purposes of this discussion, it is assumed that a consumer has indicated an implicit or explicit interest in the presented first piece of advertising content. Implicit interest may be predicted by, for example, a long dwell time in the vicinity of a display device while the advertising content is being presented. Explicit interest may be determined by, for example, the consumer's selection of a presented coupon for a product or service. Other ways in which the consumer may indicate interest implicitly or explicitly are described elsewhere herein.

Once the consumer has indicated an interest in the first piece of advertising content and is in the retail establishment, the consumer has entered a critical advertising zone 907. The critical advertising zone 907 is the period in which second and subsequent pieces of advertising content that is displayed to the consumer have maximum impact. FIG. 9 illustrates that the critical zone begins at the time period following the first piece of advertising content, in which the consumer is within the retail environment, and ends at the moment of decision, when the consumer selects the product or service for purchase. The critical zone is particularly valuable for advertisers because it is where the consumer makes purchasing decisions and is more focused on the shopping experience, unlike when the consumer is at home watching television or engaged in some other activity. Moreover, because of the implicit or explicit indication of interest by the consumer to the first piece of advertising content 905, the system is able to better target a second or subsequent piece of advertising content to the consumer. Therefore, the disclosed system determines advertising content to display to the consumer in the critical zone to influence the consumer to make a desired purchasing decision.

The number of pieces and type of advertising content that is be presented by the system to consumers in the critical zone 907 will depend on a variety of factors that are described in additional detail herein, including, for example, internal and external events, observed behavior of the consumer or groups of consumers, demographics of the location surrounding the retail establishment, the path of the consumer within the retail establishment, the predicted time between the first piece of advertising content and the moment of decision, and the like. In all cases, however, at least a second piece of advertising content 906 is presented to the consumer at a time when the consumer is inside of the retail environment. As previously described herein, the disclosed method and system takes into account a variety of factors when determining which piece of advertising content is suitable for presentation on a particular display device at any given time. Among these factors are the identity of products or services in which the consumer has previously expressed an interest, the consumer's physical proximity to the desired products or services within the retail environment, and the intended effect of the advertising upon the consumer. The consumer may express interest implicitly, for example by dwelling in a region for an extended period when a particular piece of advertising content is presented on a display device, or explicitly, for example by selecting a particular coupon or a recipe involving a product that is presented on a display device. The consumer may indicate implicit or explicit interest by various other means, for example by opting to view more information about an advertised product, such as ingredients, nutritional information, installation or repair instructions, recommended combinations, or warnings about a product. Regarding the intended effect of the advertising content on the consumer, the disclosed method and system is capable of selecting second and subsequent pieces of advertising content aimed to accomplish at least three distinct goals: product reinforcement; product change; and product supplementation.

For product reinforcement, the consumer is presented with advertising content that reinforces an advertising message directed to the same product or category of products. For example, in product reinforcement, a consumer may be presented an advertisement related to a can of green beans upon entering a retail environment. The consumer may indicate interest in the can of green beans, for example, by viewing a recipe that incorporates the beans or by selecting a coupon to purchase the beans at a discount. The consumer may also indicate an interest by obtaining nutritional information about the beans. Upon continuing to shop within the retail establishment, the consumer may receive additional pieces of advertising content directed to the green beans. The advertising content may be delivered to the consumer on one or more of the fixed displays located within the retail environment. The advertising content may be delivered to the consumer at varying times and locations within the retail environment. For example, as the consumer shops in the seafood department within the retail environment, advertising content for green beans may again appear on a display device, reinforcing the consumer's initial interest in the green beans. As the consumer continues shopping and makes his way to the canned food aisle, yet another piece of advertising content for green beans may be presented. Such advertising content is particularly timely because the consumer is in the direct vicinity of the green beans. By presenting advertising content for green beans when the consumer is physically within reach of the green beans, the consumer is more likely to actually purchase the item, thereby increasing the effectiveness of the reinforcement advertising. The disclosed system may again present the consumer with advertising content for green beans as the consumer nears the check-out point in order to reinforce the product benefits through the checkout procedure. Doing so may have the effect of lessening the likelihood that the consumer will change his mind about the green beans in the final moments before paying for his purchases. In this way, the consumer has repeatedly received advertising related to the green beans and is therefore more likely to complete the transaction.

For product change, the consumer is presented with advertising content that is designed to change the consumer's purchasing decision, such as persuading a consumer who intends to purchase a particular brand of a product to instead purchase a competitor's brand. For example, in product change, the system may predict that the consumer is likely to purchase Pepsi-Cola soft drink. The prediction of likely product purchases may be based on multiple factors, including without limitation, the purchase behavior of groups of consumers that frequent the particular retail environment, dwell times of the consumer within various regions of the retail environment, or a previous implicit or explicit indication of interest in a particular brand of product. For example, the population of consumers that visit the store may have a preponderance of Pepsi-Cola drinkers. As another example, a consumer may indicate an interest in Pepsi-Cola by selecting a coupon that is presented on a display device. For product change, the system may identify a goal of converting the consumer from a Pepsi-Cola drinker to a Coca-Cola drinker. As the consumer traverses within the retail environment, the system therefore presents advertising content directed to Coca-Cola to the consumer. The advertising content is delivered to the consumer on one or more display devices located within the retail environment. The advertising content may be delivered to the consumer at varying times and locations within the retail environment. For example, as the consumer shops in the seafood department within the retail environment, a piece of advertising content for Coca-Cola may appear on a display device, reinforcing the desired goal for the consumer to switch from Pepsi-Cola to Coca-Cola. As the consumer continues shopping and makes his way to the soft drink aisle, yet another piece of advertising content for Coca-Cola may be displayed with a significant discount coupon. Such advertising content is particularly timely, because the consumer is in the direct vicinity of both the Pepsi-Cola and the Coca-Cola. By receiving advertising content (including, for example, a coupon) for Coca-Cola when the consumer is physically within reach of the Coca-Cola, the consumer is more likely to actually purchase the Coca-Cola instead of the Pepsi-Cola, thereby increasing the effectiveness of the product change advertising. The disclosed system may again present the consumer with advertising content for Coca-Cola as the consumer nears the check-out point in order to reinforce the product change advertising through the checkout procedure. Doing so may have the effect of lessening the likelihood that the consumer would change his mind about the Coca-Cola and revert to his usual Pepsi-Cola in the final moments before paying for his purchases. In this way, the consumer has repeatedly received advertising content persuading him to purchase Coca-Cola instead of Pepsi-Cola and is therefore more likely to purchase the Coca-Cola.

For product supplementation, a consumer is presented with advertising content that is designed to enlarge the consumer's purchasing decision, such as persuading a consumer who intends to purchase a particular product to also purchase an additional product that supplements the first product. For example, in product supplementation, the system may determine that the consumer is likely to purchase a bag of tortilla chips. The determination of likely product purchases may be based on multiple factors, including without limitation past dwell times within the retail environment or a previous implicit or explicit indication of interest in a particular type of product. For product supplementation, the system may identify a goal of persuading the consumer to buy a tub of salsa to accompany his tortilla chips. For example, the consumer may first be presented with advertising content for salsa (or both chips and salsa) when entering the retail environment. The consumer may indicate interest in the salsa, for example, by viewing a recipe using the salsa, viewing nutritional information about the salsa, or clicking to see a map of the retail environment with directions to the salsa. Upon moving through the retail environment, the consumer receives advertising content directed to the salsa. The pieces of advertising content are delivered to the consumer on display devices located within the retail environment. The advertising content may be delivered to the consumer at varying times and locations within the retail environment. For example, as the consumer shops in the produce department within the retail environment, a piece of advertising content for chips or for chips and salsa may appear on the display device, reinforcing the desired goal for the consumer to purchase salsa to accompany his chips. As the consumer continues shopping and makes his way to the tortilla chip aisle, yet another piece of advertising content for the salsa or for the salsa and chips may be displayed. Similarly, as the consumer makes his way to the salsa aisle, yet another piece of advertising content for chips or for chips and salsa may be displayed. Such advertising content is particularly timely, because the consumer is in the direct vicinity of the chips and the salsa. By receiving advertising content for chips and salsa when the consumer is physically within reach of the chips and salsa, the consumer is more likely to actually purchase the salsa to accompany his tortilla chips, thereby increasing the effectiveness of the product supplementation advertising. The disclosed system may again present the consumer with a piece of advertising content kir chips and salsa as the consumer nears the check-out point in order to reinforce the product supplementation advertising through the checkout procedure. Doing so may have the effect of lessening the likelihood that the consumer would change his mind about the salsa and instead purchase chips without the salsa in the final moments before paying for his purchases. In this way, the consumer has repeatedly received advertising content persuading him to purchase the salsa to go along with his chips and is therefore more likely to purchase the salsa.

FIG. 9 depicts three specific examples of delivering the second or subsequent piece of advertising content to consumers in retail environments. Consumer 1 represents a consumer whom the system identifies for product reinforcement advertising. Consumer 2 represents a consumer whom the system identifies for supplemental product advertising. Consumer 3 represents a consumer whom the system identifies for change product advertising. The system may determine the number of pieces of advertising content and the particular treatment to present to a consumer based on, for example, the anticipated visit time of the consumer to the retail establishment. The anticipated visit time may be estimated in a variety of ways by the system. For example, the anticipated visit time may be based on the average or median historic visit time for all consumers to the retail establishment. As another example, the anticipated visit time may be based on the estimated transit time through the retail environment. If the system anticipates, for example, that the consumer is going to purchase tennis shoes, and if tennis shoes are located in a back corner of the retail establishment which requires transit of several other departments before entry into the shoe department, the system will be able to estimate the amount of time that the consumer will be in the retail establishment as the consumer walks to the shoe department. As yet another example, even if the system has no estimate of the current product that the consumer is interested in purchasing, the system can detect the current pace of the consumer through the retail environment (including dwell time at various points within the retail environment) and use the pace to estimate the overall visit time. In general, consumers that are moving quickly through the retail environment or only have a short time within the retail environment are only targeted with a second piece of advertising content or an advertisement treatment that requires a small number of impressions. In contrast, consumers that are moving slowly through a retail environment or have an extended time within the retail environment are targeted with multiple piece of advertising content or advertisement treatments that are effective with a larger number of impressions.

In FIG. 9, Consumer 1 has been identified to receive product reinforcement advertising. As Consumer 1 walks throughout the retail environment, he stops at a kiosk displaying information on several products. Consumer 1 selects green beans on the kiosk to receive recipes that incorporate green beans, thereby providing an (explicit) indication of interest in the green beans. As Consumer 1 continues shopping in the retail environment, he eventually reaches the aisle containing green beans. Upon entry into the green bean aisle, Consumer 1 is presented with a piece of advertising content for green beans, for example on a display device situated on the shelf or on his personal cellular phone. Consumer 1 takes a can of green beans off of the shelf, places it into his shopping cart, and continues shopping in other aisles within the retail environment. Consumer 1 is presented with no further pieces of advertising content regarding the green beans, and eventually completes his purchase of the green beans and other items.

Consumer 2 has been identified to receive product supplementation advertising. The disclosed system can predict that Consumer 2 is interested in tortilla chips based on one or more implicit or explicit indications of interest (e.g., an implicit indication based on a long dwell time of the consumer in a region that contains tortilla chips, an explicit indication by selection of a coupon for tortilla chips, etc.). Accordingly, the system identifies Consumer 2 as a potential purchaser of salsa to accompany the tortilla chips. Consumer 2 thus receives a first product advertisement for salsa via a display device. For example, when Consumer 2 enters the aisle containing tortilla chips, he is presented with advertising content related to salsa. Consumer 2 places a bag of tortillas in his shopping basket. Later, as Consumer 2 walks near the salsa aisle, he again is presented with advertising content related to salsa. Consumer 2 then places a tub of salsa in his shopping cart and proceeds to other aisles within the retail environment. As Consumer 2 continues shopping, he is presented with no other advertising content relating to salsa. Consumer 2 completes his purchase of the chips and salsa, as well as other items, and then exits the retail environment.

Consumer 3 has been identified to receive product change advertising. The disclosed system can predict that Consumer 3 is likely to purchase Pepsi-Cola based on one or more implicit or explicit indications of interest discussed herein. Accordingly, the system identifies Consumer 3 as a potential convert to Coca-Cola. As the consumer moves through the retail environment, the disclosed system begins product change advertising designed to persuade Consumer 3 to purchase the Coca-Cola instead of Pepsi-Cola by presenting him with an advertisement directed to Coca-Cola. As Consumer 3 continues shopping, he is presented with another piece of advertising content for Coca-Cola as he passes the deli section of the retail environment, thereby reinforcing the product change advertising message to choose Coca-Cola instead of Pepsi-Cola. Later, as Consumer 3 walks near the soft drink aisle, he again is presented with advertising content related to Coca-Cola. Consumer 3 then places a bottle of Coca-Cola in his shopping cart and proceeds to other aisles within the retail environment. Finally, Consumer 3 is presented with yet another piece of advertising content directed to Coca-Cola with the aim of preventing Consumer 3 from making a last-minute switch back to Pepsi-Cola. Consumer 3 completes his purchase of the Coca-Cola and other items, and then exits the retail environment.

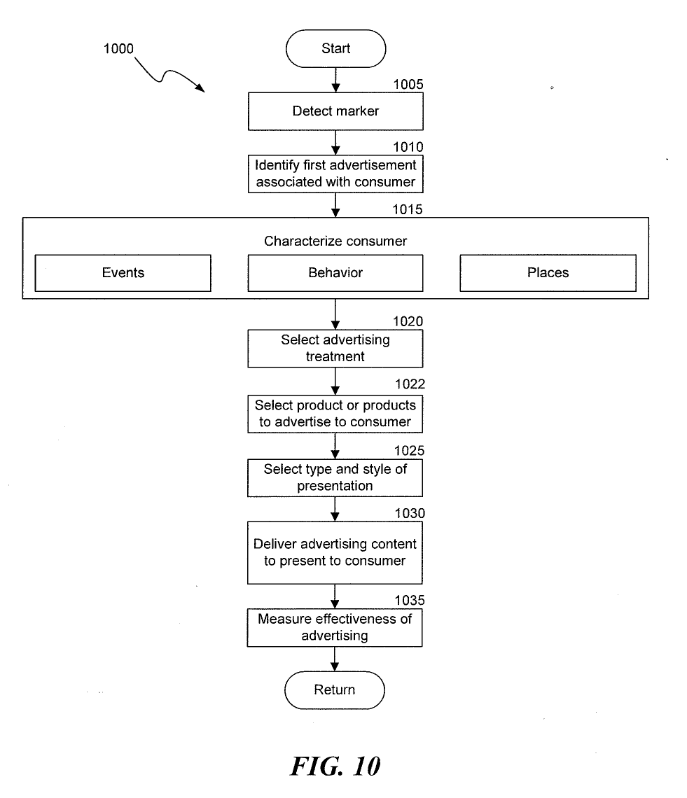

FIG. 10 is a flow diagram of a process 1000 implemented by the disclosed system to determine an advertising treatment (e.g.,, product reinforcement, product supplementation, or product change), to determine a type and style of advertising delivery, and to select advertising content to display to a consumer while inside of a retail environment. At block 1005, the system detects the entry of the consumer into the retail environment. The detection may be accomplished by a variety of different means, for example by a region manager 215 detecting the location of a consumer marker within a detection region, as previously described herein. At block 1010, the system identifies a first piece of advertising content associated with the consumer based on an implicit or explicit indication of interest by the consumer. Once the implicit or explicit interest of the consumer in a product or service contained in a first piece of advertising content has been identified, the system uses the indication of interest to determine the type of advertising treatment that it will present to the consumer in the second and subsequent pieces of advertising content.

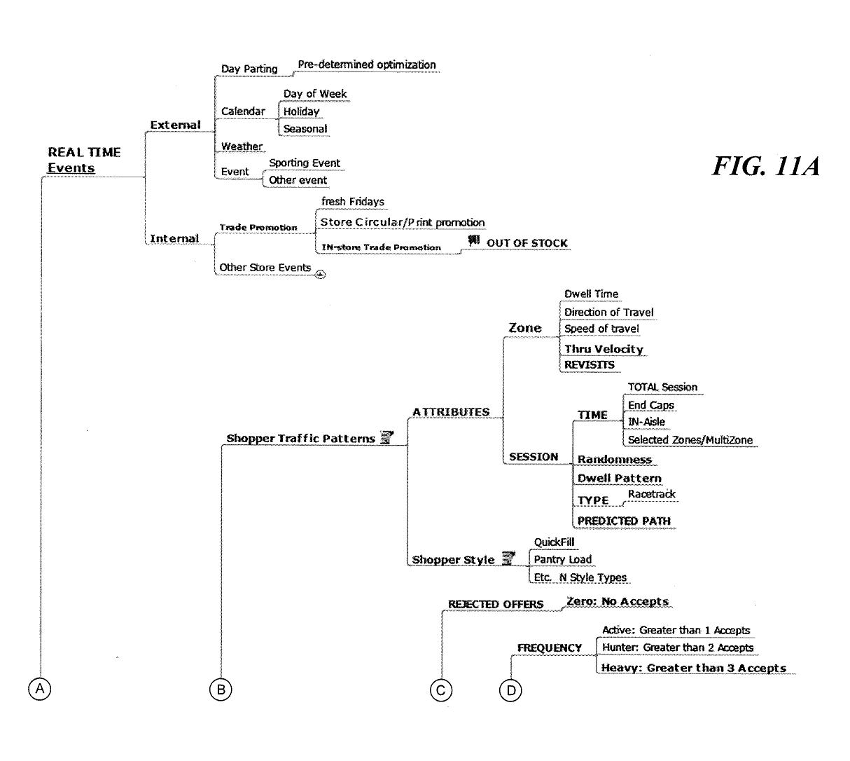

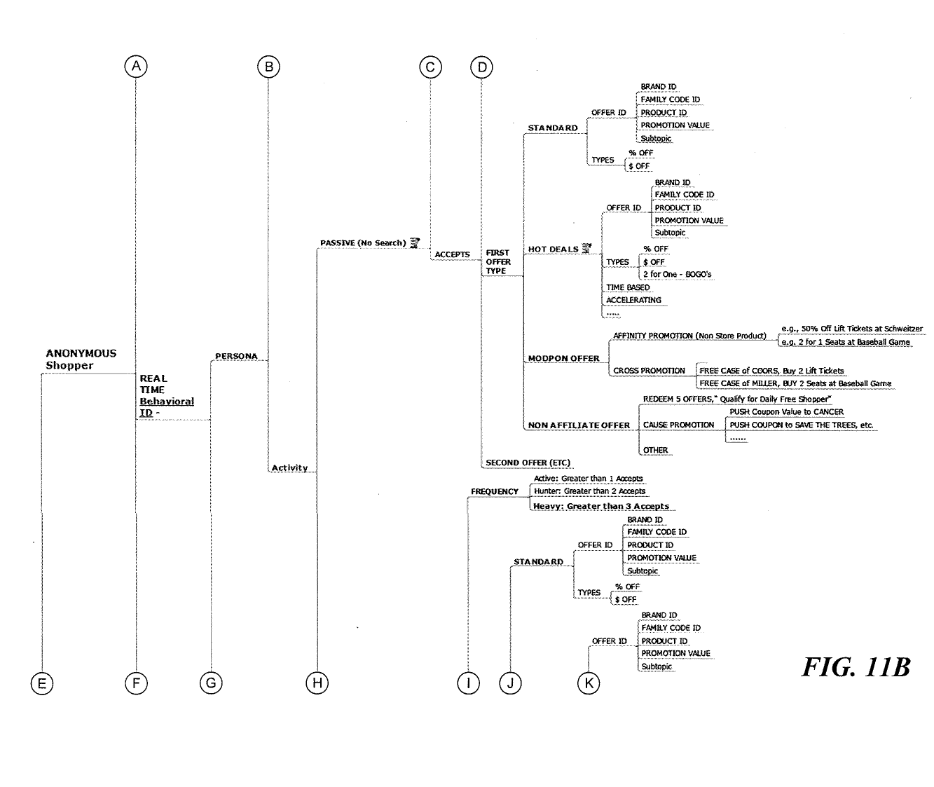

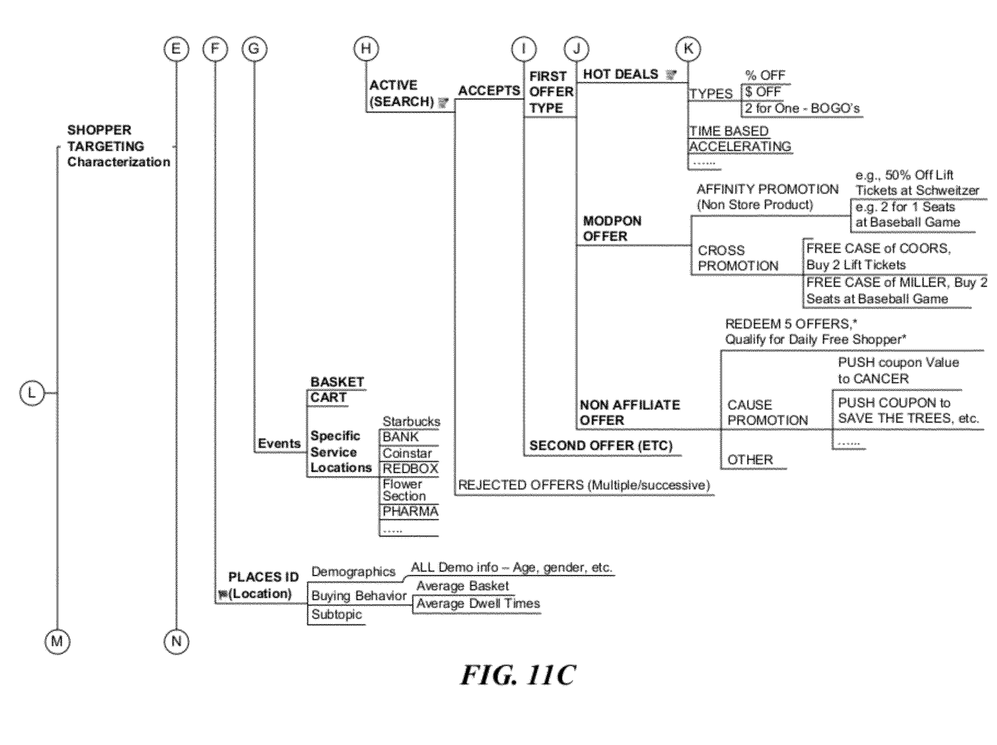

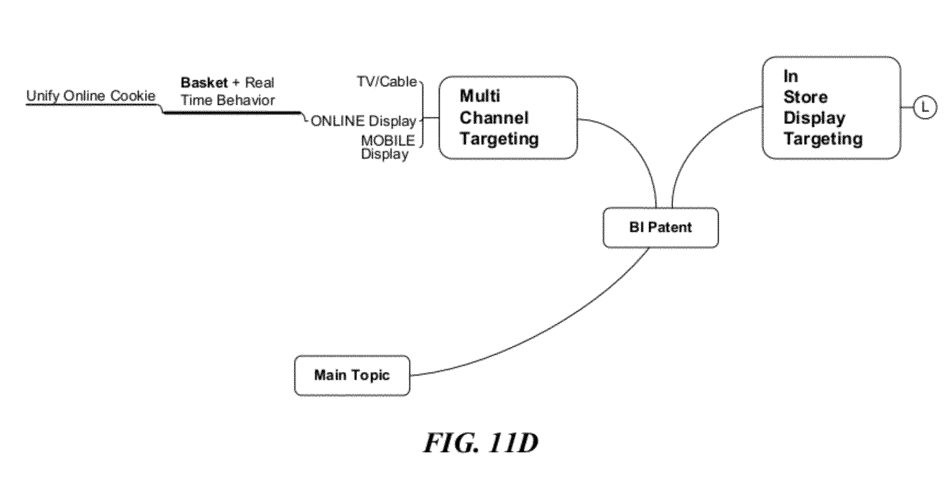

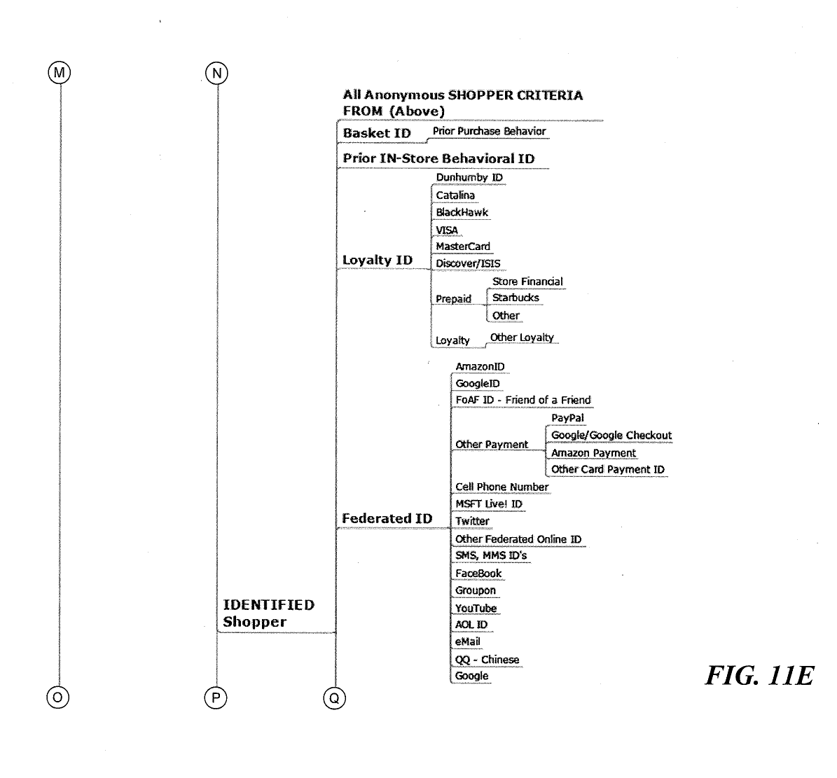

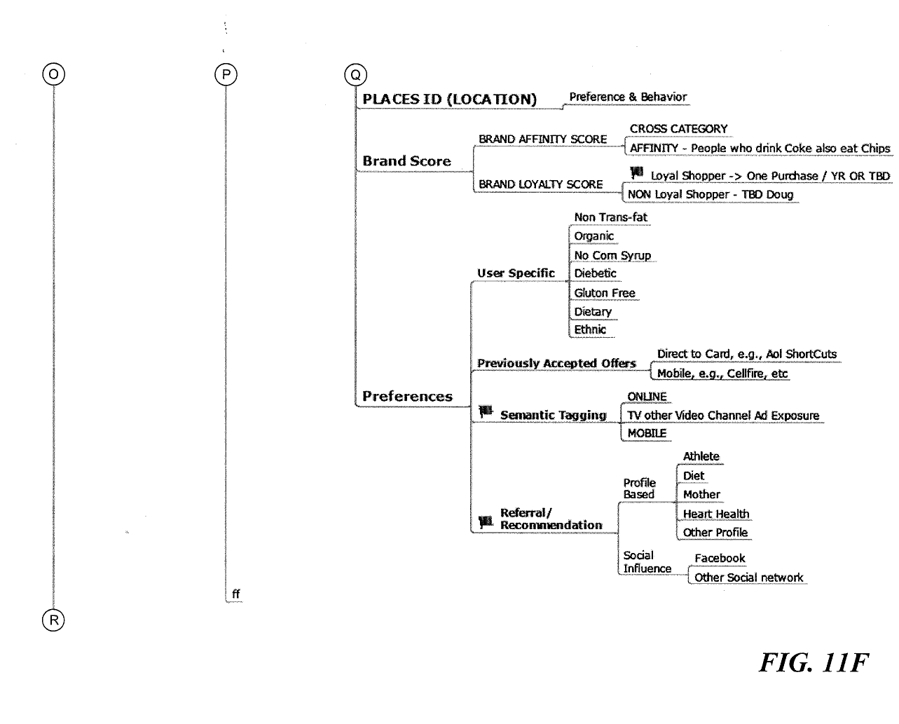

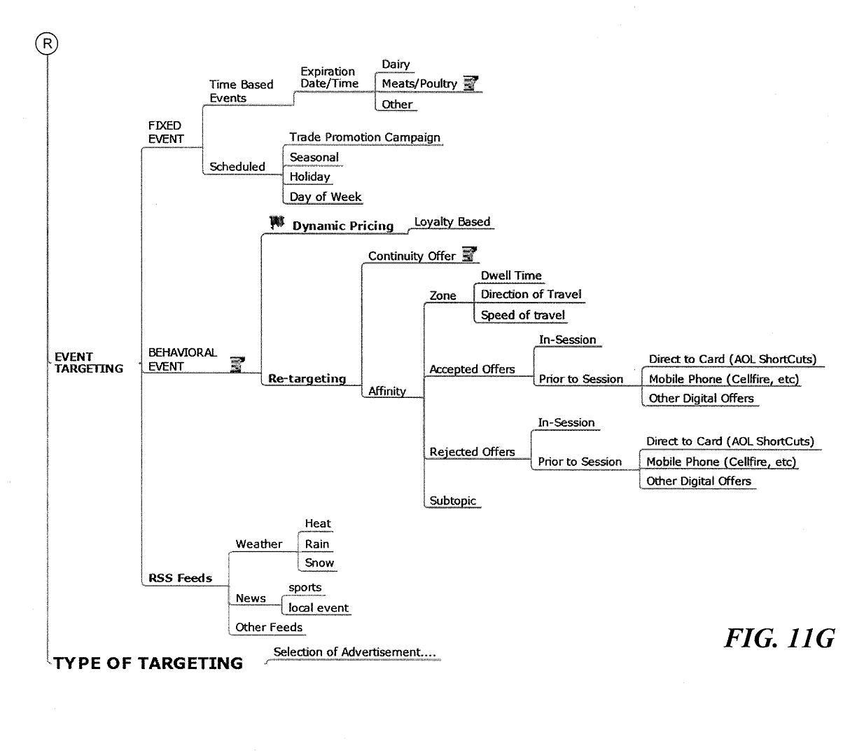

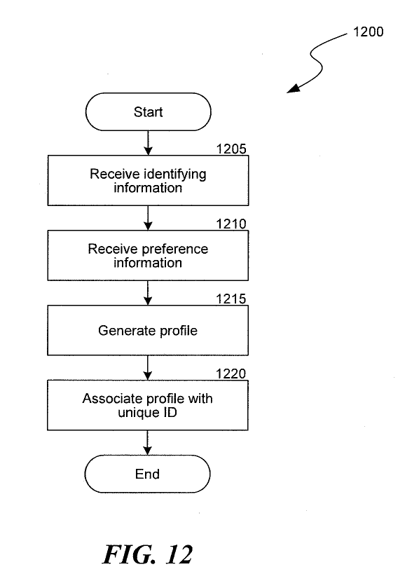

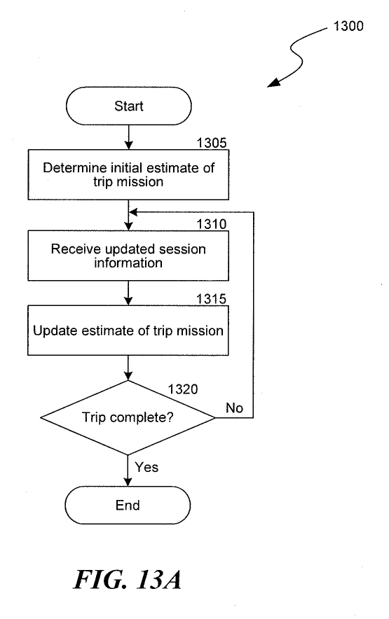

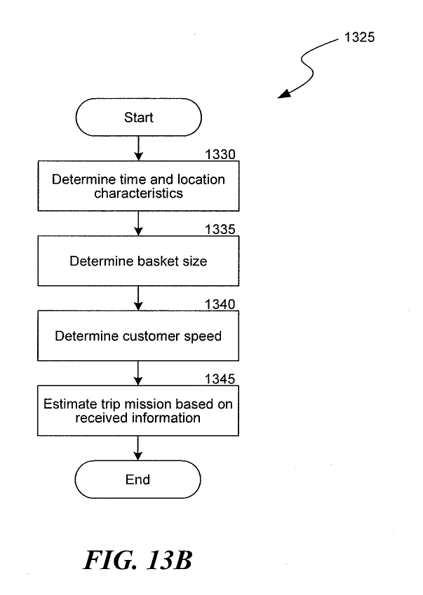

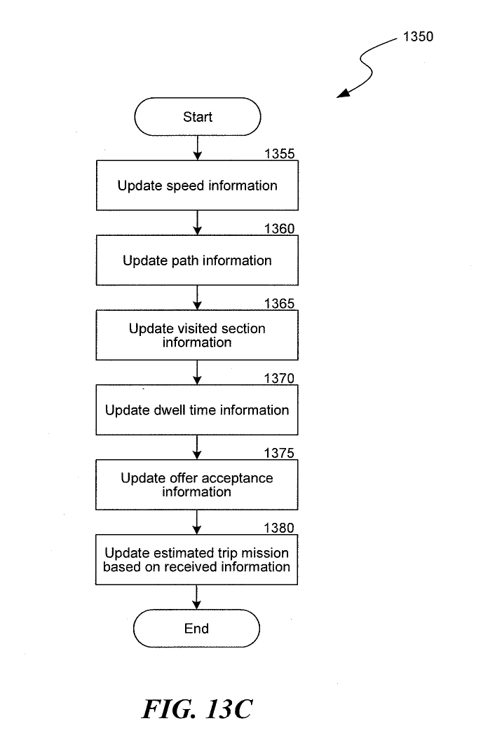

At block 1015, the system characterizes the consumer based on one or more factors. Note that consumers that are detected by the system are frequently anonymous, meaning that the system is unable to associate a detected consumer with any personally-identifiable information associated with that consumer. In the absence of any personally-identifiable information, the system uses one or more factors to characterize the consumer. Three general classes of factors are listed in block 1015, namely events, behavior, and places. “Events” are current external or internal circumstances, such as the time of day, the day of the week, whether it's a holiday, the weather, or whether any special event is happening (e.g., the Super Bowl), etc. “Behavior” refers to the observed behavior of the consumer, such as the consumer's path through the retail establishment, the pace of the consumer, the dwell locations of the consumer in the retail establishment, whether the consumer has selected any offers, the type of offers that the consumer selects, etc. “Places” refers to the geographical location of the retail establishment, including the demographic characteristics of the consumers that typically visit the retail establishment, the characteristics of the businesses that surround the retail establishment, etc. FIG. 11A-11G is a mind map of the various factors that may be taken into account by the system when characterizing the consumer. It will be appreciated that the factors enumerated in FIG. 11A-11G is merely representative, and that other similar or dissimilar factors not enumerated therein may also be taken into account by the system. The system uses or more of the factors to characterize the consumer and to assign the consumer to a particular profile. For example, the system may use these factors to estimate the customer's trip mission. The system may characterize a consumer as being on a “quick trip” trip mission and likely to pick up only a few items during a brief visit to the retail establishment. As another example, the system may characterize a consumer as being on a “fill the pantry” trip mission and likely to spend an extended time browsing the store and purchasing a significant amount of products. Based on the factors considered by the system, the system characterizes the consumer by assigning the consumer to a pre-determined profile in block 1015.

After characterizing the consumer, processing continues to a block 1020. At block 1020, the system selects a particular advertising treatment (e.g., product reinforcement, product change, product supplementation) for the consumer. The system selects the advertising treatment based on the anticipated visit time of the consumer to the retail establishment or other factors (e.g., a push by an advertiser to sell a particular product within a particular timeframe). The anticipated visit time to the retail establishment may be calculated by the system based on the path that the consumer is likely to take while in the retail environment, the average velocity of the consumer, and any likely dwell times along that path. The path may be predicted based on, for example, a record of historical paths taken by similar groups of consumers or by all consumers. The path may also be predicted based on the anticipated purchases that the consumer will make.

After the advertising treatment is selected, at block 1022 the system selects the product or products that will be advertised to the consumer. The selection of a product or products for advertising to the consumer is based on a variety of factors previously described herein, including a previous implicit or explicit indication of interest in a product by the consumer, the particular products or categories of products contained in the current zone, the consumer's dwell time, or other shopping behavior observed during the present shopping sessions. At block 1025, the system selects the type of advertising content and style of presentation for the advertising content. For example, the system may select a coupon to present to the consumer, a video of the product in use, a recipe or instructions associated with the product, etc. The type and style of the advertising content from which to select may be limited by the available types and styles of advertising content that is associated with the selected product or products. In certain cases, for example, only a single piece of advertising content may be available based on the selected product or products.

At block 1030, the system delivers the selected advertising content to the consumer via a display device or multiple display devices. At block 1035, the system measures the effectiveness of the advertising that the system presented to the consumer. The measurement may be made, for example, by comparing a list of products purchased by the consumer during the shopping session to a list of products for which advertisements were presented to the consumer during the same shopping session. A person skilled in the art will appreciate that certain steps of process 1000 may be executed in a different order. For example, the step of determining the likely path of the consumer (block 1015) may occur before the step of identifying a first advertisement associated with the consumer (block 1010). A person skilled in the art will further appreciate that certain steps of flow diagram 1000 may be repeated one or more times in order to advertise multiple distinct products to a consumer during a single shopping session.

FIG. 13A is a flowchart of a process 1300 for estimating a customer's trip mission. In some embodiments, the system implements the process 1300 as part of the processing of block 1015 of FIG. 10. According to the process 1300 of FIG. 13, the system iteratively estimates the customer's trip mission during the time the customer is shopping. As each new piece of session information is received, the system can update the estimate to give a progressively more accurate picture of the customer's goals on the current trip. The system can then select advertising consistent with the customer's trip mission.

Processing begins at block 1305, where the system determines an initial estimate of the customer's trip mission. An exemplary method for determining the initial estimate is described below with reference to FIG. 13B. As discussed below, the system generally determines the initial estimate based on information that is available soon after the customer enters the store. In one embodiment, the system uses a predetermined default value as the initial trip mission. For example, statistics show that the majority of shopping trips are quick trips; therefore, the system may be configured to initially assume a quick trip for all customers.

After the system determines the initial estimate of the customer's trip mission, processing proceeds to block 1310, where the system receives updated session information. The session information may include any of the information discussed above, such as regions or zones entered, dwell time in each region or zone, and offers accepted. Processing then proceeds to block 1315, where the system updates its estimate of the customer's trip mission. An exemplary method for updating the estimate of the customer's trip mission is described below with reference to FIG. 13C.

Processing then proceeds to decision block 1320, where the system determines if the customer's trip is complete. A trip is complete, for example, if the system detects that the marker associated with the customer has entered the checkout area or can no longer be detected in the store. If the trip is not yet complete, the system returns to block 1310 to receive additional session information. Otherwise, the process ends.

FIG. 13B is a flowchart of an exemplary process 1325 for determining the initial estimate of the customer's trip mission. The process 1325 may be executed as part of the processing of block 1305 of FIG. 13A. As stated above, the system determines the initial estimate of the trip mission based on information that is available soon after the customer enters the store. Processing begins at block 1330, where the system determines time and location characteristics of the customer's trip. In this step, the system uses information for the particular store to gather information to estimate the customer's trip mission. In particular, in some embodiments, the system stores information correlating the time of day with the likelihood of a type of trip mission occurring at each corresponding time or during each corresponding period. The stored information may be specific to a particular store or aggregate information across a chain of stores or based on the type of store (e.g., grocery stores, warehouse stores, etc.). For example, the system may have information indicating that trips in the evening are likely to be quick trips, while trips in the morning are likely to be fill ins.

Processing then proceeds to block 1335, where the system determines the size or type of the basket selected by the customer. In some embodiments, the system may be able to determine whether the customer has selected a basket at all. As used herein, “basket” refers to anything that the customer may use to carry items within the store, such as a shopping cart, basket, trolley, etc. If a marker is connected to the basket, the system can determine the particular type of basket by looking up the type of basket associated with the marker. The system may determine that the customer has not selected a basket by determining that a marker (e.g., the customer's mobile phone) has entered the store and is not associated with a basket. The type of basket is useful because the size of the basket tends to correlate with the number of items that the customer intends to buy or the amount of time the customer intends to spend in the store. In particular, a customer who selects a hand-held basket for shopping is most likely on a quick trip. In contrast, a customer who selects a cart or other wheeled basket is more likely on a fill up trip.

Processing then proceeds to block 1340, where the system determines the customer's initial speed within the store. In particular, customers generally move faster when they are on a trip mission that puts a premium on time, such as a quick trip. For example, a customer who moves at 1 m/s is typically on a quick trip, while a customer who moves at 0.5 m/s or slower is typically on a fill up or major stock up. Generally, the system can determine the customer's speed by tracking the marker for a short period of time and using tracking data to determine a distance traveled over the period of time.

Processing then proceeds to block 1345, where the system estimates the customer's trip mission based on some or all of the collected information. The initial estimate may be based on a weighting of the factors discussed above, such that particular factors have a stronger influence on the initial estimate. For example, the system may consider basket size to be the most important factor; in this case, the system would estimate that the customer is on a quick trip (or similar trip mission) in response to the customer selecting a hand-held basket, even if the customer does not move quickly through the store. After the system has determined the initial estimate, the process exits.

FIG. 13C is a flowchart of a process 1350 for updating the customer's estimated trip mission. The process 1350 may be executed as part of the processing of block 1315 of FIG. 13A. As discussed above, the update is generally based on activity information stored in the session information.

Processing begins at block 1355, where the system updates speed information for the customer. As discussed above, the system can determine the customer's speed by tracking the marker and determining the distance covered over a period of time. Processing then proceeds to block 1360, where the system determines or updates its information on the customer's path through the store. The path is the route that the customer takes in moving through the store and may be determined by monitoring the position of the marker as the marker moves between different zones in the store. The path information is useful because customers choose different paths depending on their trip mission. For example, a customer on a quick trip will generally take a direct route to a particular product, while customers on other missions may follow a meandering route through departments at the edges of the store, such as the perishable departments (e.g., meat, milk, etc.).

Processing then proceeds to block 1365, where the system determines or updates its information on the store departments, sections, or product categories that the customer has visited. For example, quick trips are generally linked to a small number of categories (e.g., less than 3), while customers who visit a very large number of categories (e.g., greater than 15) are generally on a major stock up. Customers visiting between 3 and 15 categories are generally engaged in a partial fill or fill in trip. The system may also determine specific preferences based on time spent in particular departments, sections, or product categories. For example, the system may be able to determine gender or ethnicity based on time spent in the women's cosmetics or ethnic foods categories, respectively. Processing then proceeds to block 1370, where the system updates its dwell time information. Typically, customers on trip missions that prioritize time (e.g., a quick trip) will exhibit very short dwell times, while customers on trip missions that prioritize value (e.g., major stock up) will have longer dwell times.

Processing then proceeds to block 1375, where the system updates its information on offers that the customer has accepted or rejected. Acceptance or rejection of particular offers generally correlates with particular types of trip missions. If the customer accepts an offer, the system can adjust its estimate to account for the customer's interest in that type or class of product. Similarly, if the customer rejects an offer (e.g., by leaving the area without interacting with the offer), the system can adjust its estimate to account for the customer's lack of interest. Information about whether the customer has accepted or rejected an offer is useful because a goal of presenting offers is often to change the nature of the customer's trip mission in order to increase revenue from the customer. For example, the system may present offers for premium items (e.g., ice cream) to a customer on a quick trip to encourage the customer to add a few more items to the basket, thereby converting the trip mission to a partial fill. Similarly, the system may present offers for staples (e.g., paper towels) to a customer on a partial fill to convert the trip mission to a fill in or major stock up.

Other factors may also be used by the system to estimate the trip mission. For example, the system may use any of the factors illustrated in the mind map of FIGS. 11A-11G (or similar factors) to estimate the trip mission of a customer.

Processing then proceeds to block 1380, where the system updates the estimated trip mission based on the received information. As with the block 1345 of FIG. 13B, the system may update the estimate by weighting the factors discussed above according to a predetermined priority. For example, the system may consider information on the offers accepted by the customer to have the highest predictive value when estimating the trip mission. In such a case, the system might ignore speed or other factors in favor of the conclusions based on the accepted offer information. After the system has updated the estimated trip mission, the process exits.

The estimated trip mission may be used at any point to determine advertising to present to the customer. In particular, in the process 1000 of FIG. 10, the system may use the estimated trip mission in blocks 1020, 1025, or 1030 to determine an advertising treatment, particular products to advertise, or type and style of presentation for advertising. For example, because customers on a quick trip prioritize time over money, the system may present these customers with advertisements for premium-priced items, such as ice cream, rather than advertisements for staples, such as soap or paper towels. Similarly, because quick trips are usually intended to satisfy one day's needs, such as for an evening meal, the system may also provide advertisements for deals relating to ready-to-eat meals. In contrast, customers on a major stock up mission are value-sensitive and are shopping for both short-term and long-term needs. For these customers, the system might emphasize buy one and get one free deals or advertisements for staples.

While the process 1000 was described in the context of an anonymous consumer, it will be appreciated that the techniques described herein may also be applied when the consumer is known (i.e., the consumer can be associated with personally-identifiable information). In situations where the consumer is known, additional factors may be used to characterize the consumer and target advertising content to the consumer. For example, the consumer's past purchase behavior may be used to predict future purchases of the consumer. As another example, the consumer's past paths through the retail establishment may be used to better predict the consumer's likely path through the retail establishment. In general, the system may use any information associated with the past activities of the consumer to better select and target new advertising content to the consumer.

In particular, in some embodiments, the system may link in-store behavior with information collected from a customer's online behavior. FIG. 12 is a flowchart of a process 1200 for linking online customer information to in-store information. In block 1205, an online service receives identifying information for a customer. The information may be provided by a customer registering with a shopping website or an online identity provider, such as through Facebook or Google ID. In general, the online customer information may be stored or registered by any service suitable for maintaining an online identity, such as services provided by individual stores, shopping aggregators, online federated identity providers (e.g., Facebook), and the like. Processing then proceeds to block 1210, where the system receives preference information from the customer. In this step, the customer may indicate product preferences that can be used to optimize the type of offers delivered on in-store display devices. Preferences could include any factor that differentiates products, such as organic, ethnic, value/premium, calorie-based, non-Trans fat, low fat, sugar/non sugar, salt/no salt, price points (value/premium), private label vs. national brand, etc. The customer may also register specific brands or product categories that are of particular interest. The service may also allow the customer to identify or link to preferences of friends, such as preferences provided through a social network (e.g., Facebook). A customer would be motivated to provide product preference information to increase the likelihood of receiving relevant advertisements while in a store. The online service may also offer incentives for registering and providing product preference information, such as gift cards or other premium offers.

Processing then proceeds to block 1215, where the system generates a profile for the customer or links the customer's preferences to an existing profile. Processing then proceeds to block 1220, where the system links the customer's profile to a unique identifier. In this step, the system links the customer's online profile to the customer's offline existence. For example, the system may link the online profile with a unique identifier on the customer's mobile phone. As noted above, the customer's mobile phone may be used as the marker. Such linking may be accomplished by the customer providing his or her mobile phone number. Thus, linking the online profile to the mobile phone allows the system to consider online profile information in providing advertising while the customer is in the store. The system may use this information, for example in step 510 of FIG. 5 or step 1015 of FIG. 10 to retrieve information for selecting advertising to provide to the customer.

From the foregoing, it will be appreciated that specific embodiments of the invention have been described herein for purposes of illustration, but that various modifications may be made without deviating from the invention. Accordingly, the invention is not limited to the specific embodiments described herein.

I/We claim:

1. A computer-implemented method for the automatic delivery of advertising content to a consumer based on the consumer's indication of interest in an item or service available in a retail environment, the method comprising:
receiving information reflecting initial actions of a customer in a retail establishment based on a marker associated with the customer;
determining an initial estimate of a trip mission associated with the customer based on the information relating to the customer's initial actions in the retail establishment, wherein the trip mission is an estimate of the customer's priorities while shopping in the retail establishment;
presenting a first advertisement to the customer, the first advertisement being determined based at least in part on the initial estimate of the trip mission and displayed on a first display device associated with the retail establishment;
receiving session information relating to additional actions of the customer actions within the retail establishment;
determining an updated estimate of the trip mission based on the initial estimate of the trip mission and the received session information; and
presenting a second advertisement to the customer, the second advertisement being determined based at least in part on the updated estimate of the trip mission and displayed on a second display device associated with the retail establishment.

2. The method of claim 1, wherein an action is the selection of the size or type of a basket by the customer.

3. The method of claim 1, wherein an initial action is the customer's speed after entering the retail establishment.

4. The method of claim 1, wherein the session information includes at least one of information on the customer's path in the retail establishment, information on an amount of time spent in a particular area of the retail establishment, or information on sections of the retail establishment visited by the customer.

5. The method of claim 1, the method further comprising:
receiving an indication of the customer's acceptance or rejection of an offer associated with an advertisement presented to the customer,
wherein the session information includes information relating to the acceptance or rejection and wherein the updated estimate is based on the information relating to the acceptance or rejection.

6. The method of claim 1, the method further comprising:
determining customer-specific information associated with the customer, the customer-specific information including at least one of the customer's past purchase history, the customer's product preferences, or the customer's association with a loyalty program,
wherein at least one of the first advertisement or the second advertisement is determined based at least in part on the customer-specific information.

7. The method of claim 6, wherein the customer-specific information is determined based on an online profile generated by the customer and associated with the marker.

8. The method of claim 7, wherein the marker is associated with the customer's mobile phone.

9. The method of claim 6, wherein the customer-specific information is determined based on a information retrieved from the customer's mobile phone.

10. The method of claim 6, wherein the customer-specific information is determined by correlating the marker with information stored during a previous visit by the customer.

11. The method of claim 1, wherein the trip mission is associated with a preference for a class of products and wherein presenting a second advertisement includes presenting an advertisement associated with the class of products.

12. The method of claim 1, wherein the estimate of the trip mission indicates that the customer places a high priority on time and a low priority on value and wherein the first advertisement or the second advertisement is for a premium-priced product.

13. The method of claim 1, wherein the initial estimate of the trip mission associated with the customer is further determined based on the types of trip missions that are typically associated with the retail establishment.

14. The method of claim 1, wherein the initial estimate of the trip mission associated with the customer is further determined based on the time of day.

15. A system for the automatic delivery of advertising content to a consumer based on the consumer's indication of interest in an item or service available in a retail environment, the system comprising:
a location system configured to track a customer in a retail establishment based on a marker associated with the customer;
a session database configured to store information associated with the customer's movements and actions in the retail establishment; and
a session manager configured to:
determine an initial estimate of a trip mission associated with the customer based on information from the location system relating to the customer's initial actions in the retail establishment, wherein the trip mission is an estimate of the customer's priorities while shopping in the retail establishment;
present a first advertisement to the customer, the first advertisement being determined based at least in part on the initial estimate of the trip mission and displayed on a first display device associated with the retail establishment;
receive session information from the session database relating to additional actions of the customer actions within the retail establishment;
determine an updated estimate of the trip mission based on the initial estimate of the trip mission and the received session information; and
present a second advertisement to the customer, the second advertisement being determined based at least in part on the updated estimate of the trip mission and displayed on a second display device associated with the retail establishment.

16. The system of claim 15, wherein an action is the selection of the size or type of a basket by the customer.

17. The system of claim 15, wherein the session information includes at least one of information on the customer's path in the retail establishment, information on an amount of time spent in a particular area of the retail establishment, or information on sections of the retail establishment visited by the customer.

18. The system of claim 15, the wherein the session manager is further configured to:
receive an indication of the customer's acceptance or rejection of an offer associated with an advertisement presented to the customer,
wherein the session information includes information relating to the acceptance or rejection and wherein the updated estimate is based on the information relating to the acceptance or rejection.

19. The system of claim 15, wherein the session manager is further configured to:
determine customer-specific information associated with the customer, the customer-specific information including at least one of the customer's past purchase history, the customer's product preferences, or the customer's association with a loyalty program,
wherein at least one of the first advertisement or the second advertisement is determined based at least in part on the customer-specific information.

20. The system of claim 19, wherein the customer-specific information is determined based on an online profile generated by the customer and associated with the marker.

21. The system of claim 19, wherein the customer-specific information is determined by correlating the marker with information stored during a previous visit by the customer.

22. The system of claim 15, wherein the trip mission is associated with a preference for a class of products and wherein presenting a second advertisement includes presenting an advertisement associated with the class of products.

23. The system of claim 15, wherein the initial estimate of the trip mission associated with the customer is further determined based on the types of trip missions that are typically associated with the retail establishment.

24. A computer-readable medium containing instructions for controlling a computing system including a processor and an associated storage area for the automatic delivery of advertising content to a consumer based on the consumer's indication of interest in an item or service available in a retail environment, by a method comprising:
receiving information reflecting initial actions of a customer in a retail establishment based on a marker associated with the customer;
determining an initial estimate of a trip mission associated with the customer based on the information relating to the customer's initial actions in the retail establishment, wherein the trip mission is an estimate of the customer's priorities while shopping in the retail establishment;
presenting a first advertisement to the customer, the first advertisement being determined based at least in part on the initial estimate of the trip mission and displayed on a first display device associated with the retail establishment;
receiving session information relating to additional actions of the customer actions within the retail establishment;
determining an updated estimate of the trip mission based on the initial estimate of the trip mission and the received session information; and
presenting a second advertisement to the customer, the second advertisement being determined based at least in part on the updated estimate of the trip mission and displayed on a second display device associated with the retail establishment.

25. The computer-readable medium of claim 24, wherein an action is the selection of the size or type of a basket by the customer.

26. The computer-readable medium of claim 24, wherein the session information includes at least one of information on the customer's path in the retail establishment, information on an amount of time spent in a particular area of the retail establishment, or information on sections of the retail establishment visited by the customer.

27. The computer-readable medium of claim 24, the method further comprising:
receiving an indication of the customer's acceptance or rejection of an offer associated with an advertisement presented to the customer,
wherein the session information includes information relating to the acceptance or rejection and wherein the updated estimate is based on the information relating to the acceptance or rejection.

28. The computer-readable medium of claim 24, the method further comprising:
determining customer-specific information associated with the customer, the customer-specific information including at least one of the customer's past purchase history, the customer's product preferences, or the customer's association with a loyalty program,
wherein at least one of the first advertisement or the second advertisement is determined based at least in part on the customer-specific information.

29. The computer-readable medium of claim 28, wherein the customer-specific information is determined based on an online profile generated by the customer and associated with the marker.

30. The computer-readable medium of claim 24, wherein the initial estimate of the trip mission associated with the customer is further determined based on the types of trip missions that are typically associated with the retail establishment.

31. The computer-readable medium of claim 24, wherein the initial estimate of the trip mission associated with the customer is further determined based on the time of day.
